(19) United States
(12) Patent Application Publication
(10) Pub. No.: US 2019/0126605 A1
(43) Pub. Date: May 2, 2019

(54) ASSEMBLY AND METHOD FOR CREATING FOLDERS AND FOLDER POCKETS FROM PRINTABLE BLANK SHEETS

(71) Applicant: Blank Acquisition, LLC d/b/a Blanks/USA, Brooklyn Park, MN (US)

(72) Inventor: Andrew R. Ogren, Woodbury, MN (US)

(21) Appl. No.: 16/172,481

(22) Filed: Oct. 26, 2018

Related U.S. Application Data
(60) Provisional application No. 62/577,479, filed on Oct. 26, 2017.

(51) Int. Cl. B32B 43/00; B32B 7/14; B32B 38/00

(52) U.S. Cl. CPC B32B 43/006; B32B 38/10; B32B 38/0004; B32B 7/14

(57) ABSTRACT

A printable blank sheet includes a sheet with a first layer and a second layer attached to a bottom side of the first layer. Slit-over-perforation lines extend through the sheet. The slit-over-perforation lines include cuts running through the first layer, and perforations running through the second layer. A folder is cut into the sheet with a periphery of the folder defined by the slit-over-perforation lines.

### CROSS-REFERENCE TO RELATED APPLICATION(S)

This application claims priority to U.S. Provisional Application No. 62/577,479, filed on Oct. 26, 2017, and entitled “Assembly and Method for Creating Folders and Folder Pockets from Printable Blank Sheets” the disclosure of which is incorporated by reference in its entirety.

### BACKGROUND

The present invention relates to printable blank sheets, and in particular, to printable blank sheets that are capable of being formed into folders and folder pockets.

Custom print materials have become a common way for businesses to market themselves. Custom print materials that are typically used in advertising include two-dimensional products like postcards, flyers and door hangers, as well as three-dimensional products like golf ball boxes, candy boxes and pop-up calendars. Typically, custom print materials are sent to print shops that specialize in preparing custom print materials, as the materials have had to be printed and assembled by specialized machines. As a result, having custom print materials made can be costly and time-consuming. Further, specialty print shops typically require custom print materials to be ordered in large amounts.

Some printable blank templates are currently available for creating custom print materials without having to send them to print shops. These templates are die-cut with perforations and scored lines. The perforations surround the desired shape of the object and the scored lines indicate where the object should be folded if the object is a three-dimensional structure. The drawback to the currently available die-cut templates is that it is hard to detach the desired objects from the excess sheet when the objects have an intricate shape. Trying to separate the perforated lines often causes tearing of the object, which affects the strength and image of the resulting structure. The perforations surrounding the object can also leave rough edges on the structure where the perforations were torn apart. Further, it is time consuming to remove the objects from the sheet, especially if taking care not to tear the object as it is removed from the sheet.

### SUMMARY

A printable blank sheet includes a sheet with a first layer and a second layer attached to a bottom side of the first layer. Slit-over-perforation lines extend through the sheet. The slit-over-perforation lines include cuts running through the first layer, and perforations running through the second layer. A folder pocket is cut into the sheet with a periphery of the folder pocket defined by the slit-over-perforation lines.

A printable blank sheet includes a sheet with a sheet layer attached to a top side of a laminate layer, and a coating layer attached to a bottom side of the laminate layer. Slit-over-perforation lines extend through the sheet. The slit-over-perforation lines include cuts running through the sheet layer along the slit-over-perforation lines, perforations running through the laminate layer along the slit-over-perforation lines, and perforations running through the coating layer along the slit-over-perforation lines. A folder pocket is cut into the sheet with a periphery of the folder pocket defined by the slit-over-perforation lines. A first adhesive strip is positioned on the folder pocket, and a first adhesive cover positioned over the first adhesive strip.

A method for creating custom folder pockets includes running a printable blank sheet through a printer. The printable blank sheet includes a first layer and a second layer attached to a bottom side of the first layer. Slit-over-perforation lines extend through the sheet and define a periphery of a folder pocket in the sheet. The slit-over-perforation lines include cuts extending through the first layer and perforations extending through the second layer. The sheet is bent along the slit-over-perforation lines to weaken and separate the slit-over-perforation lines. The folder pocket is detached from the sheet.

A printable blank sheet includes a sheet with a first layer and a second layer attached to a bottom side of the first layer. Slit-over-perforation lines extend through the sheet. The slit-over-perforation lines include cuts running through the first layer, and perforations running through the second layer. A folder is cut into the sheet with a periphery of the folder defined by the slit-over-perforation lines.

A printable blank sheet includes a sheet with a sheet layer attached to a top side of a laminate layer, and a coating layer attached to a bottom side of the laminate layer. Slit-over-perforation lines extend through the sheet. The slit-over-perforation lines include cuts running through the sheet layer along the slit-over-perforation lines, perforations running through the laminate layer along the slit-over-perforation lines, and perforations running through the coating layer along the slit-over-perforation lines. A folder is cut into the sheet with a periphery of the folder defined by the slit-over-perforation lines. A first adhesive strip is positioned on the folder, and a first adhesive cover is positioned over the first adhesive strip.

A method for creating custom folder includes running a printable blank sheet through a printer. The printable blank sheet includes a first layer and a second layer attached to a bottom side of the first layer. Slit-over-perforation lines extend through the sheet and define a periphery of a folder in the sheet. The slit-over-perforation lines include cuts extending through the first layer and perforations extending through the second layer. The sheet is bent along the slit-over-perforation lines to weaken and separate the slit-over-perforation lines. The folder is detached from the sheet.

### BRIEF DESCRIPTION OF THE DRAWINGS

FIG. 1 is a side elevation view of a slit-over-perforation line in a printable blank sheet.

FIG. 2 is a top plan view of folder pockets in the printable blank sheet.

FIG. 3 is a side cross-sectional view of the folder pockets in the printable blank sheet of FIG. 2, taken along line 3-3 of FIG. 2.

FIG. 4 is a flowchart showing how folder pockets can be formed.

FIG. 5A is a perspective view of the printable blank sheet as it is being run through a printer.

FIG. 5B is a top plan view of the folder pocket after it has been removed from the printable blank sheet.

FIG. 5C is a bottom plan view of the folder pocket after a tab has been folded along a scored line.

FIG. 5D is a bottom plan view of the folder pocket as an adhesive cover is removed from the tab.

FIG. 5E is a top plan view of the folder pocket after a back panel has been folded along a scored line and adhered to the tab.

FIG. 5F is a top plan view of the folder pocket as adhesive covers are removed from the back panel.

FIG. 5G is a top plan view of a folder blank after the folder pocket has been adhered to the folder blank.

FIG. 6 is a top plan view of a first embodiment of a folder in the printable blank sheet.

FIG. 7 is a side cross-sectional view of the first embodiment of the folder in the printable blank sheet of FIG. 6, taken along line 7-7 of FIG. 6.

FIG. 8 is a flowchart showing how the first embodiment of the folder can be formed.

FIG. 9A is a perspective view of the printable blank sheet as it is being run through a printer.

FIG. 9B is a top plan view of the folder after it has been removed from the printable blank sheet.

FIG. 9C is a bottom plan view of the folder after a first tab and a second tab have been folded along scored lines.

FIG. 9D is a bottom plan view of the folder as a first adhesive cover and a second adhesive cover are removed from the first tab and the second tab.

FIG. 9E is a top plan view of the folder after a first pocket panel and a second pocket panel have been folded along scored lines.

FIG. 10 is a top plan view of a second embodiment of a folder in the printable blank sheet.

FIG. 11 is a side cross-sectional view of the second embodiment of the folder in the printable blank sheet of FIG. 10, taken along line 11-11 of FIG. 10.

FIG. 12 is a flowchart showing how the second embodiment of the folder can be formed.

FIG. 13A is a perspective view of the printable blank sheet as it is being run through a printer.

FIG. 13B is a top plan view of the folder after it has been removed from the printable blank sheet.

FIG. 13C is a top plan view of the folder after a first pocket panel and a second pocket panel have been folded along scored lines.

FIG. 13D is a top plan view of the folder as a first adhesive cover and a second adhesive cover are removed from a first tab and a second tab.

FIG. 13E is a top plan view of the folder after the first tab and the second tab have been folded along scored lines.

### DETAILED DESCRIPTION

In general, the present disclosure relates to printable blank sheets that are capable of being run through a printer or copier. The printable blank sheets include slit-over-perforation lines running through the sheet and defining the shape of objects in the sheet. Specifically, the objects can include folders and folder pockets. The objects can be separated from the sheet by breaking the sheet along the slit-over-perforation lines. The slit-over-perforation lines include a cut line through a first layer of the sheet and perforations running through a second layer of the sheet and a coating. The slit-over-perforation lines are advantageous, because they leave a clean edge when objects are separated along the slit-over-perforation lines.

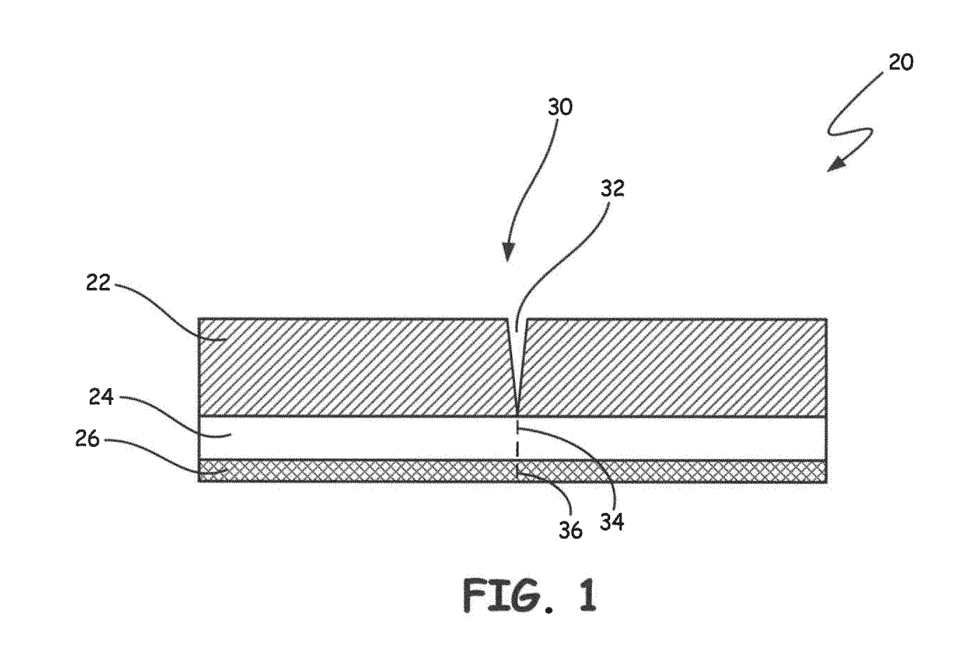

FIG. 1 is a side elevation view of slit-over-perforation line 30 in printable blank sheet 20. Printable blank sheet 20 includes sheet layer 22, laminate layer 24, and coating layer 26. Slit-over-perforation line 30 includes cut 32, perforation 34, and perforation 36. Perforation 34 and perforation 36 are represented by a dashed line in FIG. 1.

Sheet 20 is made out of three layers of materials, including sheet layer 22, laminate layer 24, and coating layer 26. Sheet layer 22 is located on a top side of sheet 20. Laminate layer 24 runs through the middle of sheet 20, with sheet layer 22 on top and coating layer 26 on bottom. Coating layer 26 is located on a bottom side of sheet 20. Sheet layer 22 and laminate layer 24 can be attached with an adhesive, or any other suitable attachment means. Coating layer 26 can be applied to a bottom side of laminate layer 24 through any suitable means. Coating layer 26 can be applied to laminate layer 24 before or after laminate layer 24 is attached to sheet layer 22. Sheet 20 can be any thickness that is capable of being passed through a printer or copier. In alternate embodiments, sheet 20 can include additional layers of materials, such as a coating layer on a top side of sheet layer 22.

Sheet layer 22 can be made out of a normal sheet material that is capable of being printed on. Laminate layer 24 is made out of a laminate material that is capable of providing the strength to keep sheet 20 together as it is passed through a printer or copier. In the embodiment shown, laminate layer 24 is made out of a polyester material. Polyester materials can be used due to their high tensile strength. The tensile strength of laminate layer 24 should be high enough so that sheet 20 can be supported by laminate layer 24 as it is passed through a printer or copier. In the embodiment shown, the tensile strength of the polyester material is between 70 MPa (10,152.64 psi) and 270 MPa (39,160.18 psi). In alternate embodiments, any material having a strength that is capable of supporting sheet 20 can be used. Coating layer 26 can be made out of any material that is capable of being printed on.

Slit-over-perforation line 30 includes cut 32, perforation 34, and perforation 36. Cut 32 runs through sheet layer 22 and extends from a top side of sheet layer 22 to a bottom side of sheet layer 22. Perforation 34 runs through laminate layer 24, as indicated by the dashed line in FIG. 1. Perforation 36 runs through coating layer 26, as indicated by the dashed line in FIG. 1. Cut 32, perforation 34, and perforation 36 are all aligned and run longitudinally across sheet 20. Cut 32 run all the way through sheet layer 22 to separate sheet layer 22 along slit-over-perforation line 30. Perforation 34 and perforation 36 extend through laminate layer 24 and coating layer 26, respectively, and run underneath cut 32 along slit-over-perforation line 30. Slit-over-perforation line 30 thus has a continuous cut through sheet layer 22 with cut 32 and a non-continuous cut through laminate layer 24 and coating layer 26 with perforations 34 and 36.

Slit-over-perforation line 30 is created with a die after sheet 20 is constructed. The die has blades at a primary height and at a secondary height. Blades at the primary height have a height that is equal to the height of cut 32, perforation 34, and perforation 36 altogether. Blades at the secondary height have a height that is equal to the height of cut 32. The blades alternate with a blade at the primary height next to a blade at the secondary height next to a blade at the primary height, and so on. A die with this configuration will cut completely through sheet layer 22 at all locations but will only cut through laminate layer 24 and coating layer 26 at the locations of the blades with the primary height. The blades with the primary height will cut through laminate layer 24 and coating layer 26 in an alternating pattern due to the alternating placement of the blades. This is what creates perforations 34 and perforations 36 in laminate layer 24 and coating layer 26. Overall, a die with blades of alternating heights, such as the one described here, is capable of creating slit-over-perforation lines 30.

To create slit-over-perforations 30 that are capable of breaking apart when bent, laminate layer 24 should have a thickness of about 0.0127 millimeters (0.0005 inches) to 0.102 millimeters (0.004 inches), and perforations 34 and perforations 36 should have a width of about 0.8 millimeters (0.0315 inches) and 2 millimeters (0.0787 inches). In the embodiment shown, laminate layer 24 has a thickness of 0.0254 millimeters (0.001 inches) and perforations 34 and perforations 36 have a width of 1.0 millimeters (0.0394 inches). In alternate embodiments, laminate layer 24 can have any thickness and perforations 34 and perforations 36 can have any width that will allow sheet 20 to break apart along slit-over-perforation 30 when sheet 20 is bent along slit-over-perforation 30.

Slit-over-perforation line 30 runs through sheet 20 to indicate where sheet 20 can be separated. Slit-over-perforation line 30 allows a user to separate sheet 20 easily, as sheet 20 can be bent along slit-over-perforation line 30, causing perforations 34 and 36 to snap apart and separate. Separating sheet 20 along slit-over-perforation line 30 leaves a clean edge where sheet 20 is separated. There will be small microscopic marks from perforations 34 and 36, but the small microscopic marks will be unperceivable when glancing at separated edges of sheet 20.

Slit-over-perforation lines 30 are advantageous, as they allow a user to create their own custom print materials without having to order custom print materials from specialty print shops. Being able to print custom print materials with clean edges allows a user to save money and time by not having to send their orders to print shops, while at the same time maintaining the quality and professionalism of custom print materials with clean edges.

Sheet 20 is also advantageous, as laminate layer 24 is strong enough to support sheet 20 as it is passed through a printer or copier and to prevent sheet 20 from tearing. Laminate layer 24 is constructed out of a material with a high tensile strength so that laminate layer 24 remains intact when sheet 20 is passed through a printer or copier. Perforations 34 run through laminate layer 24 to facilitate the easy separation of laminate layer 24 after sheet 20 has been printed on. The strength of laminate layer 24 is also strong enough to prevent sheet 20 from tearing.

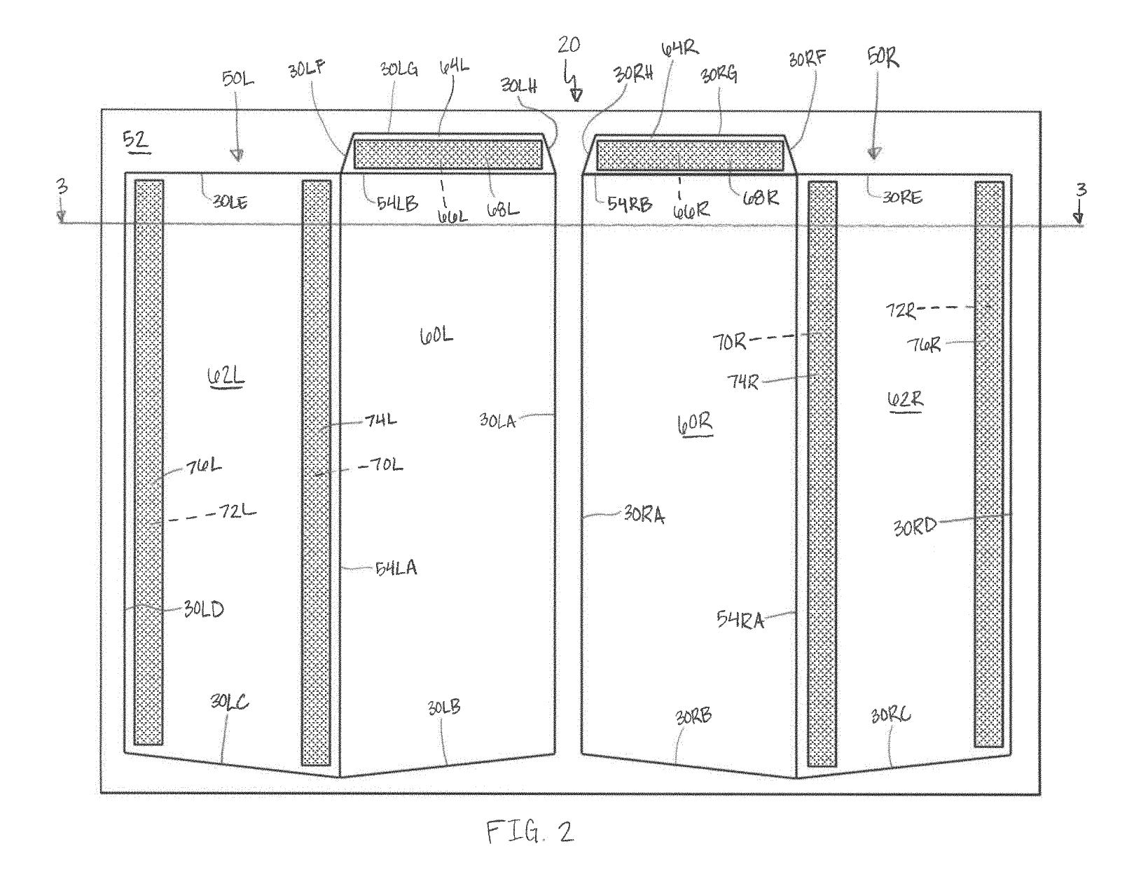

FIG. 2 is a top plan view of folder pockets 50L and 50R in printable blank sheet 20. Printable blank sheet 20 includes slit-over-perforation lines 30LA, 30LB, 30LC, 30LD, 30LE, 30LF, 30LG, 30LH, 30RA, 30RB, 30RC, 30RD, 30RE, 30RF, 30RG, and 30RH, folder pockets 50L and 50R, excess sheet area 52, and scored lines 54LA, 54LB, 54RA, and 54RB. Folder pocket 50L includes front panel 60L, back panel 62L, tab 64L, adhesive strip 66L, adhesive cover 68L, adhesive strip 70L, adhesive strip 72L, adhesive cover 74L, and adhesive cover 76L. Folder pocket 50R includes front panel 60R, back panel 62R, tab 64R, adhesive strip 66R, adhesive cover 68R, adhesive strip 70R, adhesive strip 72R, adhesive cover 74R, and adhesive cover 76R.

Printable blank sheet 20 is a flat sheet that is capable of being run through a printer. Printable blank sheet 20 includes a plurality of layers, including a sheet layer that is attached to a laminate layer and a coating on the laminate layer. Slit-over-perforation lines 30LA-30LH and 30RA-30RH extend through printable blank sheet 20 and define the peripheries of folder pockets 50L and 50R. Folder pockets 50L and 50R are positioned on printable blank sheet 20 and are capable of being removed from printable blank sheet 20 to be assembled and adhered to a folder blank. Folder pocket 50L forms a folder pocket for the left side of a folder blank, and folder pocket 50R forms a folder pocket for the right side of a folder blank. Excess sheet area 52 surrounds folder pockets 50L and 50R. After folder pockets 50L and 50R have been removed from printable blank sheet 20, excess sheet area 52 can be discarded. Slit-over-perforation lines 30LA-30LH and 30RA-30RH define the peripheries of folder pockets 50L and 50R along which folder pockets 50L and 50R can be removed from printable blank sheet 20. Slit-over-perforation lines 30LA-30LH and 30RA-30RH include a cut through a sheet layer and perforations through a laminate layer and a coating, as described in reference to FIG. 1 above. Scored lines 54LA-54LB and 54RA-54RB are placed on folder pockets 50L and 50R, respectively, and define areas where folder pockets 50L and 50R can be folded. Scored lines 54LA-54LB and 54RA-54RB are areas where printable blank sheet 20 has been put under pressure to create a line of weakness in printable blank sheet 20 along which printable blank sheet 20 can be easily folded.

Folder pocket 50L includes front panel 60L, back panel 62L, and tab 64L. Front panel 60L has sides made of slit-over-perforation line 30LA, slit-over-perforation line 30LB, scored line 54LA, and scored line 54LB. Back panel 62L has sides made of scored line 54LA, slit-over-perforation line 30LC, slit-over-perforation line 30LD, and slit-over-perforation line 30LE. Tab 64L has sides made of scored line 54LB, slit-over-perforation line 30LF, slit-over-perforation line 30LG, and slit-over-perforation line 30LH. Front panel 60L is connected to back panel 62L along scored line 54LA. Front panel 60L is connected to tab 64L along scored line 54LB. Slit-over-perforation lines 30LA-30LH define an outline of folder pocket 50L.

Front panel 60L forms a front of folder pocket 50L when folder pocket 50L is assembled, and back panel 62L forms a back of folder pocket 50L when folder pocket 50L is assembled. Tab 64L is connected to front panel 60L and is adhered to back panel 62L when folder pocket 50L is assembled to hold folder pocket 50L together. Adhesive strip 66L is positioned on tab 64L. Adhesive cover 68L covers adhesive strip 66L. Adhesive cover 68L can be removed to expose adhesive strip 66L. Adhesive strip 70L and adhesive strip 72L are positioned on back panel 72L. Adhesive cover 74L covers adhesive strip 70L, and adhesive cover 76L covers adhesive strip 72L. Adhesive cover 74L and adhesive covers 76L can be removed to expose adhesive strip 70L and adhesive strip 72L, respectively.

Folder pocket 50R includes front panel 60R, back panel 62R, and tab 64R. Front panel 60R has sides made of slit-over-perforation line 30RA, slit-over-perforation line 30RB, scored line 54RA, and scored line 54RB. Back panel 62R has sides made of scored line 54RA, slit-over-perforation line 30RC, slit-over-perforation line 30RD, and slit-over-perforation line 30RE. Tab 64R has sides made of scored line 54RB, slit-over-perforation line 30RF, slit-over-perforation line 30RG, and slit-over-perforation line 30RH. Front panel 60R is connected to back panel 62R along scored line 54RA. Front panel 60R is connected to tab 64R along scored line 54RB. Slit-over-perforation lines 30RA-30RH define an outline of folder pocket 50R.

Front panel 60R forms a front of folder pocket 50R when folder pocket 50R is assembled, and back panel 62R forms a back of folder pocket 50R when folder pocket 50R is assembled. Tab 64R is connected to front panel 60R and is adhered to back panel 62R when folder pocket 50R is assembled to hold folder pocket 50R together. Adhesive strip 66R is positioned on tab 64R. Adhesive cover 68R covers adhesive strip 66R. Adhesive cover 68R can be removed to expose adhesive strip 66R. Adhesive strip 70R and adhesive strip 72R are positioned on back panel 72R. Adhesive cover 74R covers adhesive strip 70R, and adhesive cover 76R covers adhesive strip 72R. Adhesive cover 74R and adhesive covers 76R can be removed to expose adhesive strip 70R and adhesive strip 72R, respectively.

Printable blank sheet 20 can be run through a printer or copier to have an image printed on it. After printing, folder pockets 50L and 50R can be removed from printable blank sheet 20 by separating them from printable blank sheet 10 along slit-over-perforation lines 30LA-30LH and 30RA-30RH, respectively. Folder pockets 50L and 50R will then be free-standing.

When folder pocket 50L has been removed from printable blank sheet 20, folder pocket 50L is assembled by folding tab 64L along scored line 54LB. Adhesive cover 68L is then removed to expose adhesive strip 66L. Back panel 62L is then folded along scored line 54LA and is adhered to adhesive strip 66L on tab 64L. This forms folder pocket 50L. Adhesive cover 74L and adhesive cover 76L can then be removed to expose adhesive strip 70L and adhesive strip 72L, respectively. Folder pocket 50L can then be adhered to a folder blank with adhesive strip 70L and adhesive strip 72L. Folder pocket 50L can be adhered to a left side of a folder blank.

When folder pocket 50R has been removed from printable blank sheet 20, folder pocket 50R is assembled by folding tab 64R along scored line 54RB. Adhesive cover 68R is then removed to expose adhesive strip 66R. Back panel 62R is then folded along scored line 54RA and is adhered to adhesive strip 66R on tab 64R. This forms folder pocket 50R. Adhesive cover 74R and adhesive cover 76R can then be removed to expose adhesive strip 70R and adhesive strip 72R, respectively. Folder pocket 50R can then be adhered to a folder blank with adhesive strip 70R and adhesive strip 72R. Folder pocket 50R can be adhered to a right side of a folder blank.

Forming folder pockets 50L and 50R from printable blank sheet 20 is advantageous, as it allows a user to create custom print materials without having to order the materials from specialty print shops. This saves time and money for the user. Further, separating folder pockets 50L and 50R along slit-over-perforation lines 30LA-30LH and 30RA-30RH allows folder pockets 50L and 50R to be easily separated from printable blank sheet 20. Further, slit-over-perforation lines 30LA-30LH and 30RA-30RH leave a clean edge when they are separated, thus the quality and level of professionalism of custom print materials made with slit-over-perforation lines 30LA-30LH and 30RA-30RH is similar to the quality and level of professionalism a user can get with specialty print shops.

Additionally, using laminate layer 24 (as shown in FIG. 1) with a high strength is advantageous, as it supports printable blank sheet 20 as it is passed through a printer or copier and prevents printable blank sheet 20 from tearing. Further, folder pockets 50L and 50R will include laminate layer 24, which increases the strength of folder pockets 50L and 50R. Laminate layer 24 will make folder pockets 50L and 50R stronger than previous paper structures and the film layer will make folder pockets 50L and 50R moisture resistant. This allows folder pockets 50L and 50R to be used in more settings, as stronger materials can be placed in folder pockets 50L and 50R once they are assembled into three-dimensional structures and folder pockets 50L and 50R can be used in harsher environments than was previously possible.

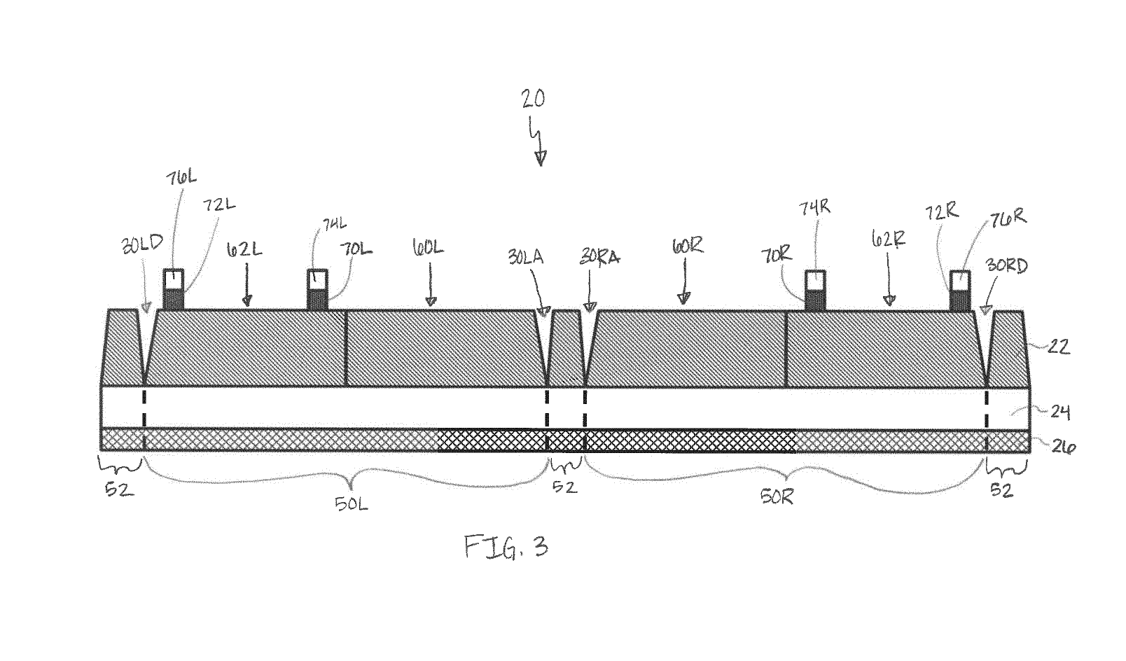

FIG. 3 is a side cross-sectional view of folder pockets 50L and 50R in printable blank sheet 20, taken along line 3-3 of FIG. 2. Printable blank sheet 20 includes sheet layer 22, laminate layer 24, coating layer 26, slit-over-perforation lines 30LA, 30LD, 30RA, and 30RD, folder pockets 50L and 50R, and excess sheet area 52. Folder pocket 50L includes front panel 60L, back panel 62L, adhesive strip 70L, adhesive strip 72L, adhesive cover 74L, and adhesive cover 76L. Folder pocket 50R includes front panel 60R, back panel 62R, adhesive strip 70R, adhesive strip 72R, adhesive cover 74R, and adhesive cover 76R.

Printable blank sheet 20 includes sheet layer 22, laminate layer 24, and coating layer 26. A bottom side of sheet layer 22 is attached to a top side of laminate layer 24, and a bottom side of laminate layer 24 is attached to a top side of coating layer 26. Slit-over-perforation lines 30LA, 30LD, 30RA, and 30RD extend through printable blank sheet 20 and define the separation lines between folder pockets 50L and 50R and excess sheet area 52. Folder pockets 50L and 50R and excess sheet area 52 are held in printable blank sheet 20 and each include sheet layer 22, laminate layer 24, and coating layer 26.

Folder pocket 50L includes front panel 60L and back panel 62L. Adhesive strip 70L, adhesive strip 72L, adhesive cover 74L, and adhesive cover 76L are positioned on back panel 62L. Adhesive strip 70L and adhesive strip 72L are attached to a top side of sheet layer 22. Adhesive cover 74L is attached to a top side of adhesive strip 70L, and adhesive cover 76L is attached to a top side of adhesive strip 72L. Folder pocket 50R includes front panel 60R and back panel 62R. Adhesive strip 70R, adhesive strip 72R, adhesive cover 74R, and adhesive cover 76R are positioned on back panel 62R. Adhesive strip 70R and adhesive strip 72R are attached to a top side of sheet layer 22. Adhesive cover 74R is attached to a top side of adhesive strip 70R, and adhesive cover 76R is attached to a top side of adhesive strip 72R.

Printable blank sheet 20 can be separated along slit-over-perforation lines 30LA, 30LD, 30RA, and 30RD to facilitate the easy separation of folder pockets 50L and 50R from printable blank sheet 20. To separate folder pockets 50L and 50R from printable blank sheet 20, a user needs to bend printable blank sheet 20 along slit-over-perforation lines 30LA, 30LD, 30RA, and 30RD. Bending printable blank sheet 20 along slit-over-perforation lines 30LA, 30LD, 30RA, and 30RD will break apart slit-over-perforation lines 30LA, 30LD, 30RA, and 30RD and separate folder pockets 50L and 50R and excess sheet area 52 from printable blank sheet 20 along slit-over-perforation lines 30LA, 30LD, 30RA, and 30RD. This process can continue for all slit-over-perforation lines 30LA-30LH and 30RA-30RH shown in FIG. 2. Once all slit-over-perforation lines 30LA-30LH and 30RA-30RH are separated, folder pockets 50L and 50R and excess sheet area 52 should all be separate pieces. Excess sheet area 52 can be discarded at this point and folder pockets 50L and 50R can be used for their intended purpose. Separating printable blank sheet 20 along slit-over-perforation lines 30LA-30LH and 30RA-30RH is advantageous, as the separations will leave clean edges. Having clean edges is beneficial, as it give the final product a more polished and professional look. Being able to print custom print materials without having to send the materials to a print shop will save time and money for a user. Slit-over-perforation lines 30LA-30LH and 30RA-30RH allow the user to print their own custom print materials on printable blank sheet 20 that has as high of a quality as something that is sent to a specialty print shop. Further, using laminate layer 24 with a high strength is advantageous, as it supports printable blank sheet 20 as it is passed through a printer or copier and prevents printable blank sheet 20, and the resulting folder pockets 50L and 50R, from tearing.

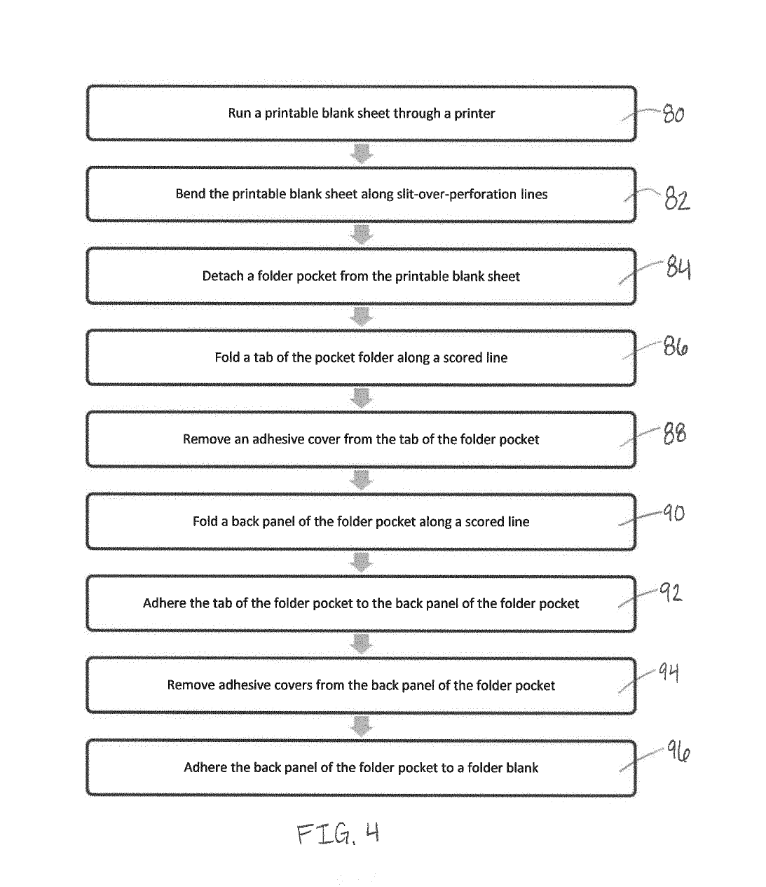

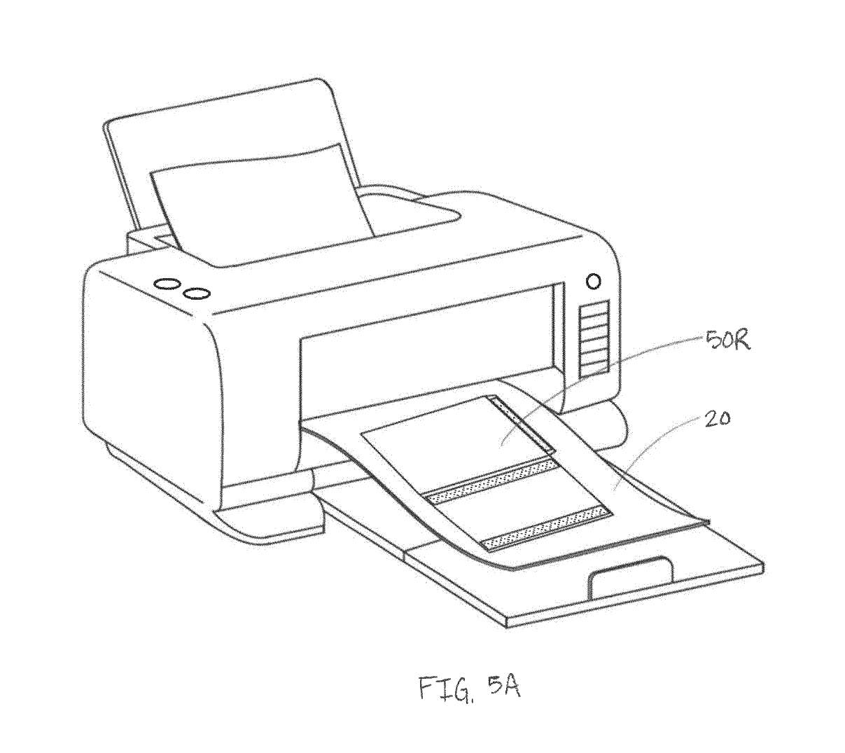

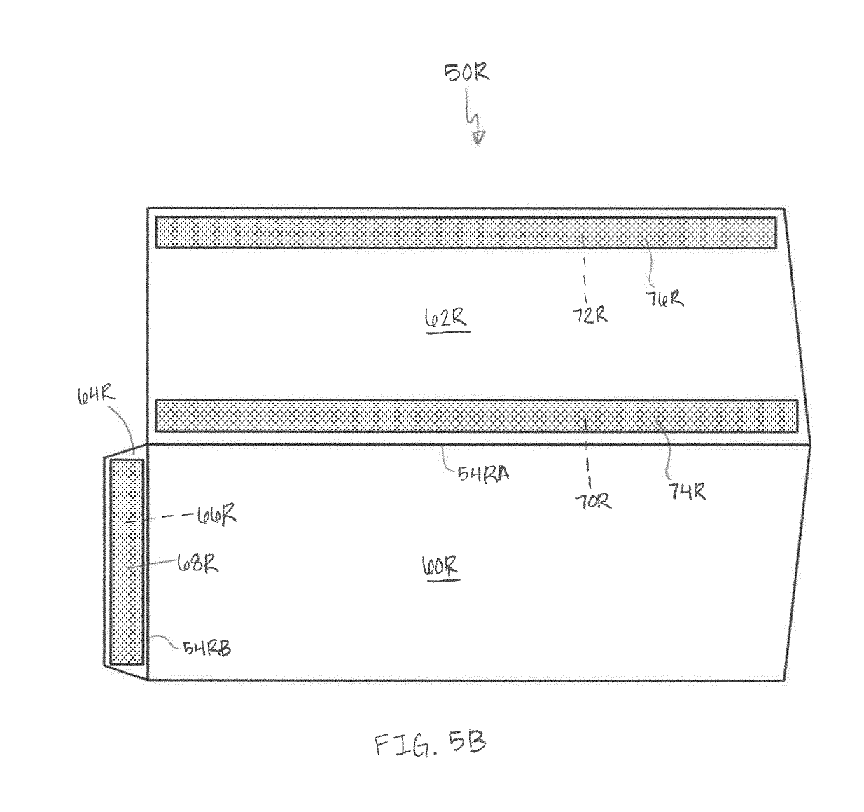

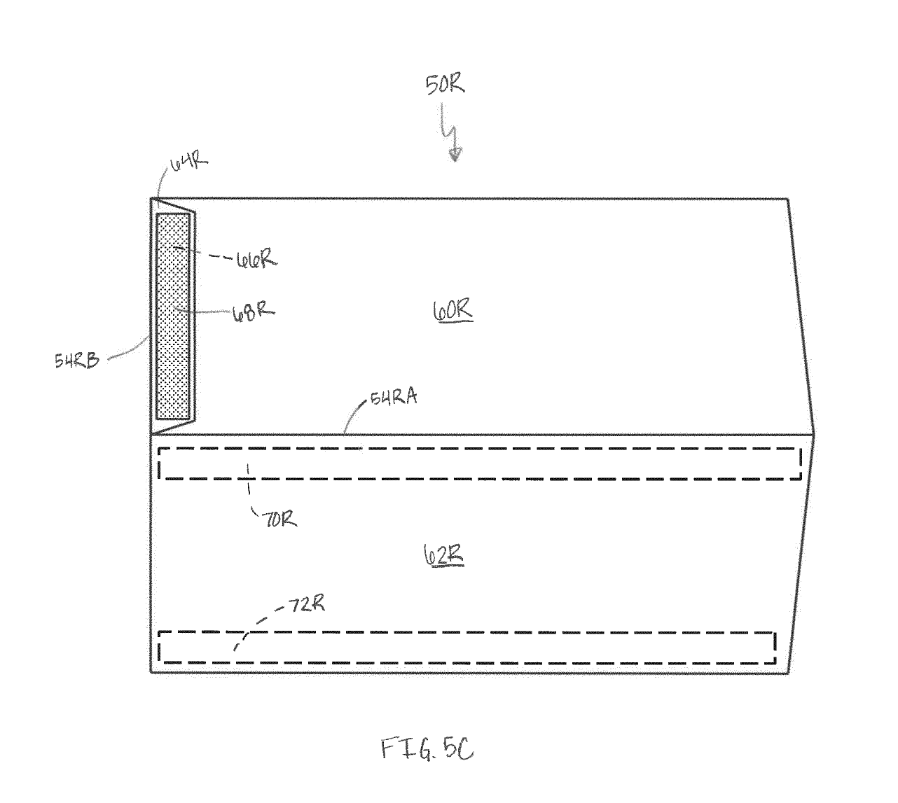

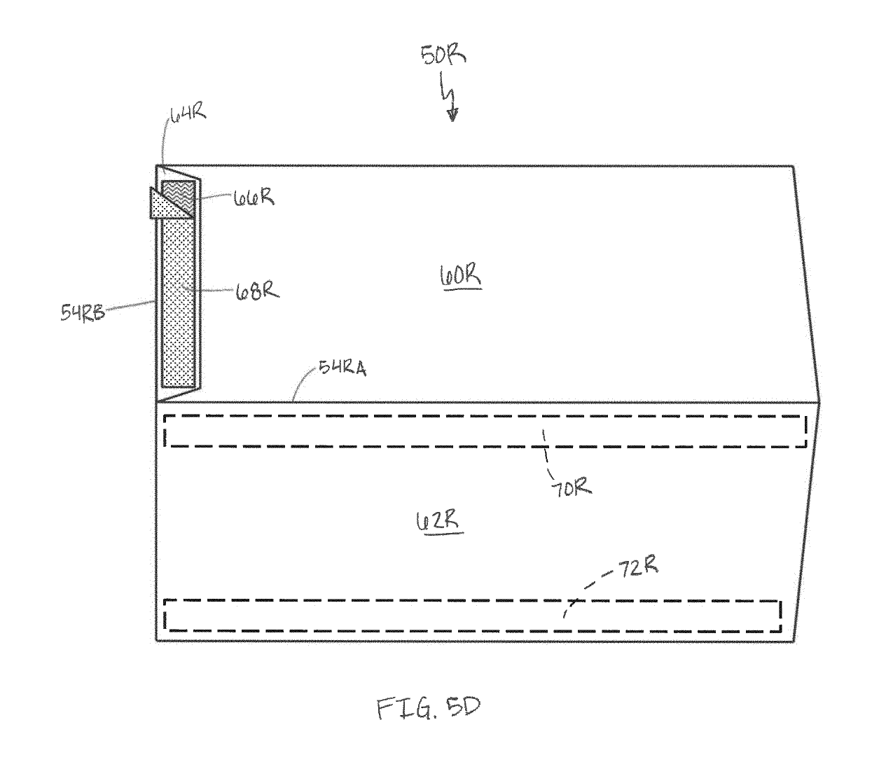

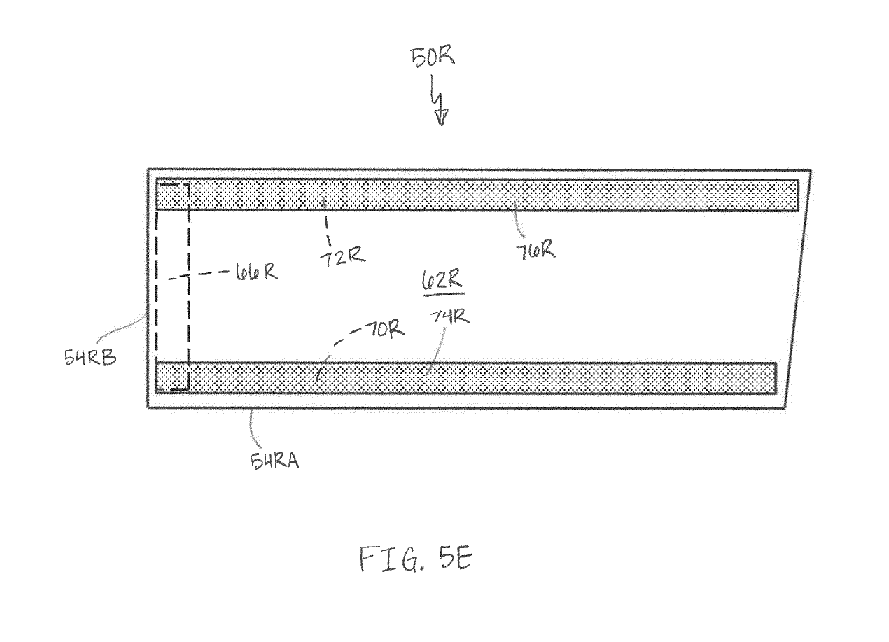

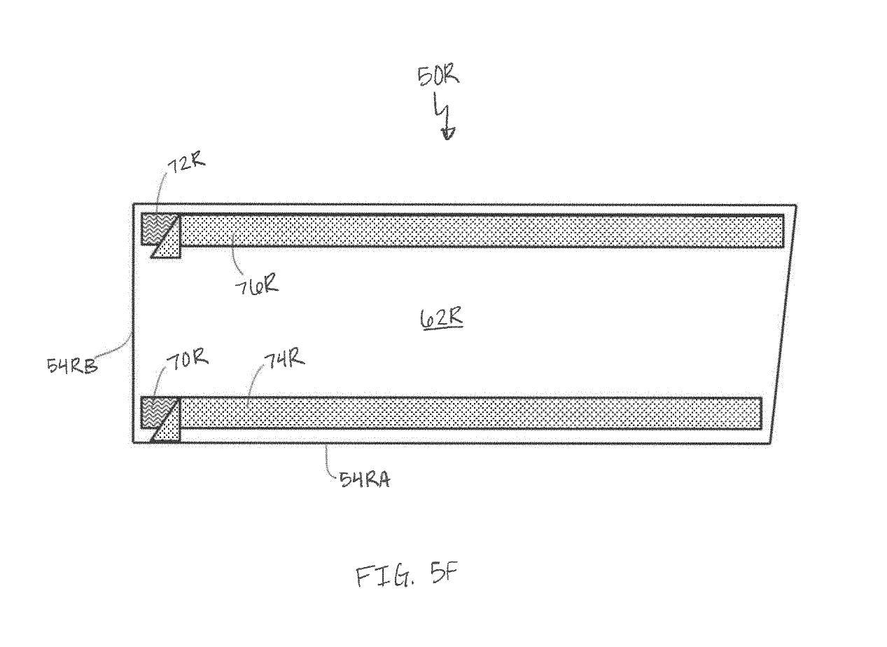

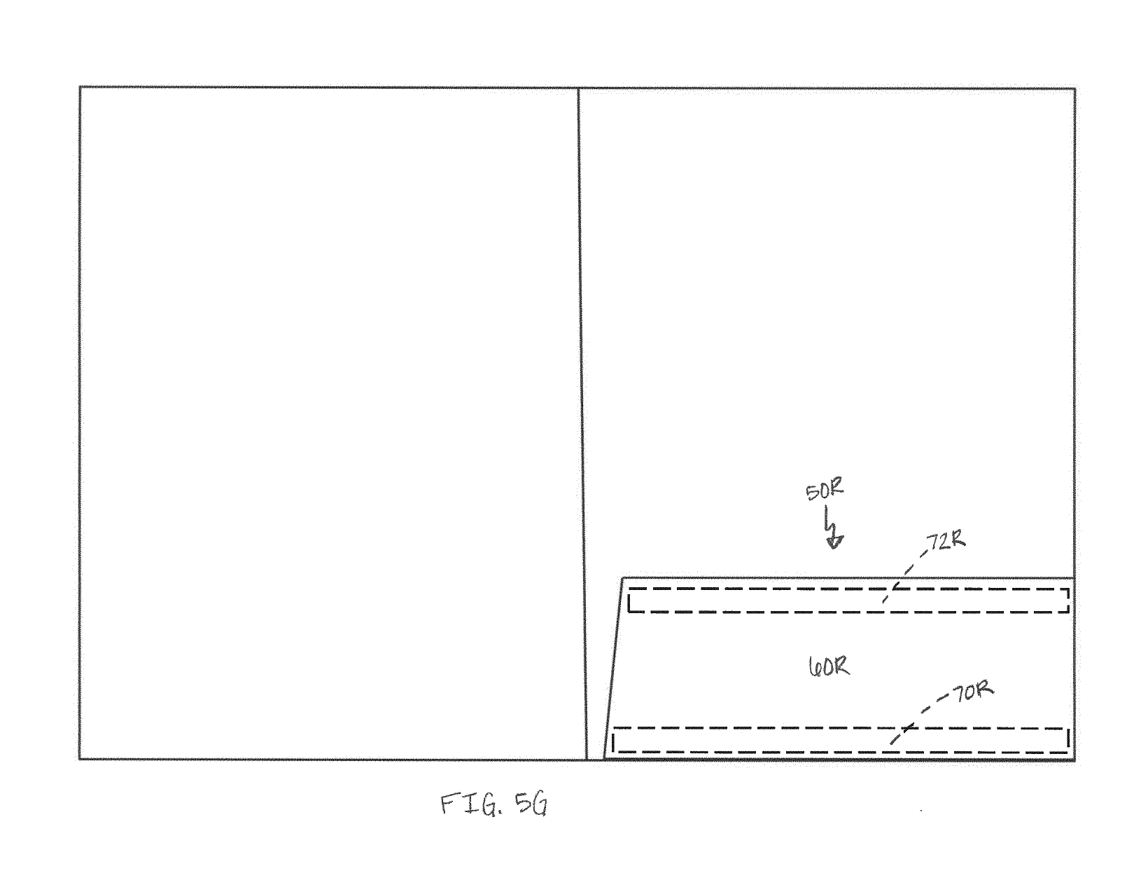

FIG. 4 is a flow chart showing how folder pockets 50L and 50R can be formed. FIG. 4 includes steps 80, 82, 84, 86, 88, 90, 92, 94, and 96 to show how folder pockets 50L and 50R can be formed. FIGS. 5A-5G illustrate steps 80-96 shown in the flow chart in FIG. 4. FIG. 5A is a perspective view of printable blank sheet 20 as it is being run through a printer. FIG. 5B is a top plan view of folder pocket 50R after it has been removed from printable blank sheet 20. FIG. 5C is a bottom plan view of folder pocket 50R after tab 64R has been folded along scored line 54RB. FIG. 5D is a bottom plan view of folder pocket 50R as adhesive cover 68R is removed from tab 64R. FIG. 5E is a top plan view of folder pocket 50R after back panel 62R has been folded along scored line 54RA and adhered to tab 64R. FIG. 5F is a top plan view of folder pocket 50R as adhesive covers 74R and 76R are removed from back panel 62R. FIG. 5G is a top plan view of a folder blank after folder pocket 50R has been adhered to the folder blank.

Step 80 includes running printable blank sheet 20 through a printer or copier, as shown in FIG. 5A. Printable blank sheet 20 will be supplied to a user from a manufacturer and will contain slit-over-perforation lines 30LA-30LH and 30RA-30RH when it is given to the user. Slit-over-perforation lines 30LA-30LH and 30RA-30RH will define the outline of folder pockets 50L and 50R in printable blank sheet 20 and will indicate defined separation lines. Printable blank sheet 20 includes sheet layer 22, laminate layer 24, and coating layer 26, as shown in FIG. 3. Both sheet layer 22 and coating layer 26 are capable of being printed on, thus printable blank sheet 20 can be printed on both sides. Prior to printing on printable blank sheet 20, a template on a computer can be used to create the custom image that is to be printed on printable blank sheet 20, and specifically folder pockets 50L and 50R.

Printable blank sheet 20 includes folder pockets 50L and 50R that are positioned in printable blank sheet 20. Folder pockets 50L and 50R are positioned so that front panels 60L and 60R, respectively, face outwards when folder pockets 50L and 50R are adhered to a folder blank. A user can print on front panels 60L and 60R of folder pockets 50L and 50R so that this information is viewable to users. Automatic imposition software can be used to create the design that is to be printed on printable blank sheet 20. The automatic imposition software allows a user to create the design for one folder pocket and then the design is automatically reproduced to be applied to every folder pocket 50L and 50R in printable blank sheet 20. The automatic imposition software will also orient the design so that it positioned properly on folder pockets 50L and 50R in printable blank sheet 20.

Step 82 includes bending printable blank sheet 20 along slit-over-perforation lines 30LA-30LH and 30RA-30RH. Slit-over-perforation lines 30LA-30LH and 30RA-30RH define the periphery of folder pockets 50L and 50R in printable blank sheet 20. To separate printable blank sheet 20 along slit-over-perforation lines 30LA-30LH and 30RA-30RH, the user can bend printable blank sheet 20 along slit-over-perforation lines 30LA-30LH and 30RA-30RH. As printable blank sheet 20 is bent along slit-over-perforation lines 30LA-30LH and 30RA-30RH, slit-over-perforation lines 30LA-30LH and 30RA-30RH will snap apart. When slit-over-perforation lines 30LA-30LH and 30RA-30RH are snapped apart, they will leave a clean-edge on the portion of printable blank sheet 20 that has been separated.

Steps 84-96 will be discussed with reference to folder pocket 50R. However, the same steps can be followed to assemble folder pocket 50L and adhere it to a folder blank. Folder pocket 50R can be adhered to a right side of a folder blank, and folder pocket 50L can be adhered to a left side of the folder blank.

Step 84 includes detaching folder pocket 50R from printable blank sheet 20. To separate folder pocket 50R from printable blank sheet 20, the user can bend printable blank sheet 20 along each slit-over-perforation line 30LA-30LH and 30RA-30RH to break them apart. This will detach folder pocket 50R and excess sheet areas 52 from printable blank sheet 20. Each side of folder pocket 50R can be detached from printable blank sheet 20 along a slit-over-perforation line 30LA-30LH and 30RA-30RH. After folder pocket 50R (and any other folder pockets on printable blank sheet 20) is separated from printable blank sheet 20, excess sheet area 52 can be discarded.

Step 86 includes folding tab 64R of folder pocket 50R along scored line 54RB. FIG. 5B shows folder pocket 50R after it has been removed from printable blank sheet 20. As seen in FIG. 5B, scored line 54RB connects tab 64R to front panel 60R. Tab 64R is folded along scored line 54RB so that adhesive strip 66R and adhesive cover 68R face away from front panel 60R when tab 64R has been folded along scored line 54RB, as shown in FIG. 5C.

Step 88 includes removing adhesive cover 68R from tab 64R of folder pocket 50R. As shown in FIG. 5C, adhesive cover 68R covers adhesive strip 66R on tab 64R. As shown in FIG. 5D, adhesive cover 68R can be peeled off of adhesive strip 66R.

Step 90 includes folding back panel 62R of folder pocket 50R along scored line 54RA. As shown in FIG. 5B, scored line 54RA connects back panel 62R to front panel 60R. Back panel 62R is folded along scored line 54RA towards tab 64R.

Step 92 includes adhering tab 64R of folder pocket 50R to back panel 62R of folder pocket 50R. As back panel 62R is folded along scored line 54RA towards tab 64R, it will come into contact with adhesive strip 66R on tab 64R, as seen in FIG. 5E. Tab 64R holds back panel 62R in position with adhesive strip 66R.

Step 94 includes removing adhesive covers 74R and 76R from back panel 62R of folder pocket 50R. As shown in FIG. 5E, adhesive covers 74R and 76R cover adhesive strips 70R and 72R, respectively. As shown in FIG. 5F, adhesive covers 74R and 76R can be peeled off of adhesive strips 70R and 72R, respectively.

Step 96 includes adhering back panel 62R of folder pocket 50R to a folder blank. After adhesive covers 74R and 76R have been removed, adhesive strips 70R and 72R will be exposed. Folder pocket 50R can then be positioned on a folder blank with back panel 62R facing the folder blank and front panel 60R facing outwards. Folder pocket 50R is adhered to the folder blank by pressing adhesive strips 70R and 72R onto the folder blank, as shown in FIG. 5G.

Steps 80-96 can be performed in any suitable order in alternate embodiments. The method shown in steps 80-96 is advantageous, as it allows a user to easily separate folder pockets 50L and 50R from printable blank sheet 20. Minimal effort needs to be expended on the behalf of the user, as slit-over-perforation lines 30LA-30LH and 30RA-30RH will easily snap apart when they are folded. Further, separating folder pockets 50L and 50R from printable blank sheet 20 along slit-over-perforation lines 30LA-30LH and 30RA-30RH will leave folder pockets 50L and 50R with clean edges. Having clean edges is advantageous, as it presents a more polished and professional look. This method is also advantageous, as it allows a user to print their own custom print materials, which saves time and money.

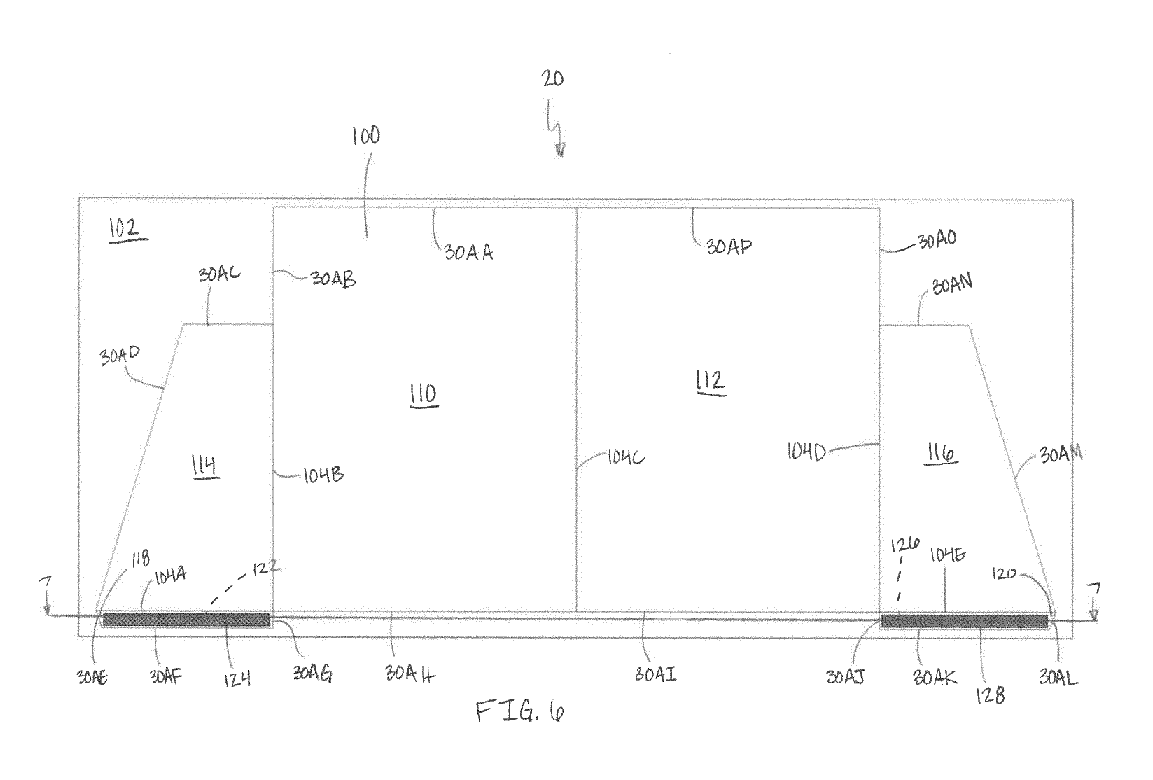

FIG. 6 is a top plan view of folder 100 in printable blank sheet 20. Printable blank sheet 20 includes slit-over-perforation lines 30AA, 30AB, 30C, 30AD, 30AE, 30AF, 30AG, 30AH, 30AI, 30AJ, 30AK, 30AL, 30AM, 30AN, 30AO, and 30AP, folder 100, excess sheet area 102, scored lines 104A, 104B, 104C, 104D, and 104E, first body panel 110, second body panel 112, first pocket panel 114, second pocket panel 116, first tab 118, second tab 120, first adhesive strip 122, first adhesive cover 124, second adhesive strip 126, and second adhesive cover 128.

Printable blank sheet 20 is a flat sheet that is capable of being run through a printer. Printable blank sheet 20 includes a plurality of layers, including a sheet layer that is attached to a laminate layer and a coating on the laminate layer. Slit-over-perforation lines 30AA-30AP extend through printable blank sheet 20 and define the peripheries of folder 100. Folder 100 is positioned on printable blank sheet 20 and is capable of being removed from printable blank sheet 20 to be assembled into a folder. Excess sheet area 102 surrounds folder 100. After folder 100 has been removed from printable blank sheet 20, excess sheet area 102 can be discarded. Slit-over-perforation lines 30AA-30AP define the periphery of folder 100 along which folder 100 can be removed from printable blank sheet 20. Slit-over-perforation lines 30AA-30AP include a cut through a sheet layer and perforations through a laminate layer and a coating, as described in reference to FIG. 1 above. Scored lines 104A-104E are placed on folder 100 and define areas where folder 100 can be folded. Scored lines 104A-104E are areas where printable blank sheet 20 has been put under pressure to create a line of weakness in printable blank sheet 20 along which printable blank sheet 20 can be easily folded.

Folder 100 includes first body panel 110, second body panel 112, first pocket panel 114, second pocket panel 116, first tab 118, and second tab 120. First body panel 110 has sides made of slit-over-perforation line 30AA, slit-over-perforation line 30AB, scored line 104B, slit-over-perforation line 30AH, and scored line 104C. Second body panel 112 has sides made of slit-over-perforation line 30AP, scored line 104C, slit-over-perforation line 30AL scored line 104D, and slit-over-perforation line 30AO. First pocket panel 114 has sides made of slit-over-perforation line 30AC, slit-over-perforation line 30AD, scored line 104A, and scored line 104B. Second pocket panel 116 has sides made of slit-over-perforation line 30AN, scored line 104D, scored line 104E, and slit-over-perforation line 30AM. First tab 118 has sides made of scored line 104A, slit-over-perforation line 30AE, slit-over-perforation line 30AF, and slit-over-perforation line 30AG. Second tab 120 has sides made of scored line 104E, slit-over-perforation line 30AJ, slit-over-perforation line 30AK, and slit-over-perforation line 30AL.

First body panel 110 is connected to second body panel 112 along scored line 104C. First body panel 110 is connected to first pocket panel 114 along scored line 104B. Second body panel 112 is connected to second pocket panel 116 along scored line 104D. First pocket panel 114 is connected to first tab 118 along scored line 104A. Second pocket panel 116 is connected to second tab 120 along scored line 104E. Slit-over-perforation lines 30AA-30AP define an outline of folder 100.

First body panel 110 and second body panel 112 form a body portion of folder 100 when folder 100 is assembled. Folder 100 can be folded along scored line 104C so that first body panel 110 forms a front of folder 100 and second body panel 112 forms a back of folder 100. First pocket panel 114 forms a pocket on the left side of folder 100 when folder 100 is assembled, and second pocket panel 116 forms a pocket on the right side of folder 100 when folder 100 is assembled. First tab 118 is connected to first pocket panel 114 and can be adhered to first body panel 110 to form a pocket with first pocket panel 114. Adhesive strip 122 is positioned on tab 118. Adhesive cover 124 covers adhesive strip 122. Adhesive cover 124 can be removed to expose adhesive strip 122. Second tab 120 is connected to second pocket panel 116 and can be adhered to second body panel 112 to form a pocket with second pocket panel 116. Adhesive strip 126 is positioned on tab 120. Adhesive cover 128 covers adhesive strip 126. Adhesive cover 128 can be removed to expose adhesive strip 126.

Printable blank sheet 20 can be run through a printer or copier to have an image printed on folder 100. After printing, folder 100 can be removed from printable blank sheet 20 by separating it from printable blank sheet 20 along slit-over-perforation lines 30AA-30AP. Folder 100 will then be free-standing.

When folder 100 has been removed from printable blank sheet 20, folder 100 is assembled by folding first tab 118 along scored line 104A. Adhesive cover 124 is then removed to expose adhesive strip 122. First pocket panel 114 is then folded along scored line 104B and adhesive strip 122 can be adhered to first body panel 110. Second tab 120 can then be folded along scored line 104E. Adhesive cover 128 is then removed to expose adhesive strip 126. Second pocket panel 116 is then folded along scored line 104D and adhesive strip 126 can be adhered to second body panel 112. Folder 100 can then be folded along scored line 104C to form a presentation folder.

Forming folder 100 from printable blank sheet 20 is advantageous, as it allows a user to create custom print materials without having to order the materials from specialty print shops. This saves time and money for the user. Further, separating folder 100 along slit-over-perforation lines 30AA-30AP allows folder 100 to be easily separated from printable blank sheet 20. Further, slit-over-perforation lines 30AA-30AP leave a clean edge when they are separated, thus the quality and level of professionalism of custom print materials made with slit-over-perforation lines 30AA-30AP is similar to the quality and level of professionalism a user can get with specialty print shops.

Additionally, using laminate layer 24 (as shown in FIG. 1) with a high strength is advantageous, as it supports printable blank sheet 20 as it is passed through a printer or copier and prevents printable blank sheet 20 from tearing. Further, folder 100 will include laminate layer 24, which increases the strength of folder 100. Laminate layer 24 will make folder 100 stronger than previous paper structures and the film layer will make folder 100 moisture resistant. This allows folder 100 to be used in more settings, as stronger materials can be placed in folder 100 once they are assembled into three-dimensional structures and folder 100 can be used in harsher environments than was previously possible.

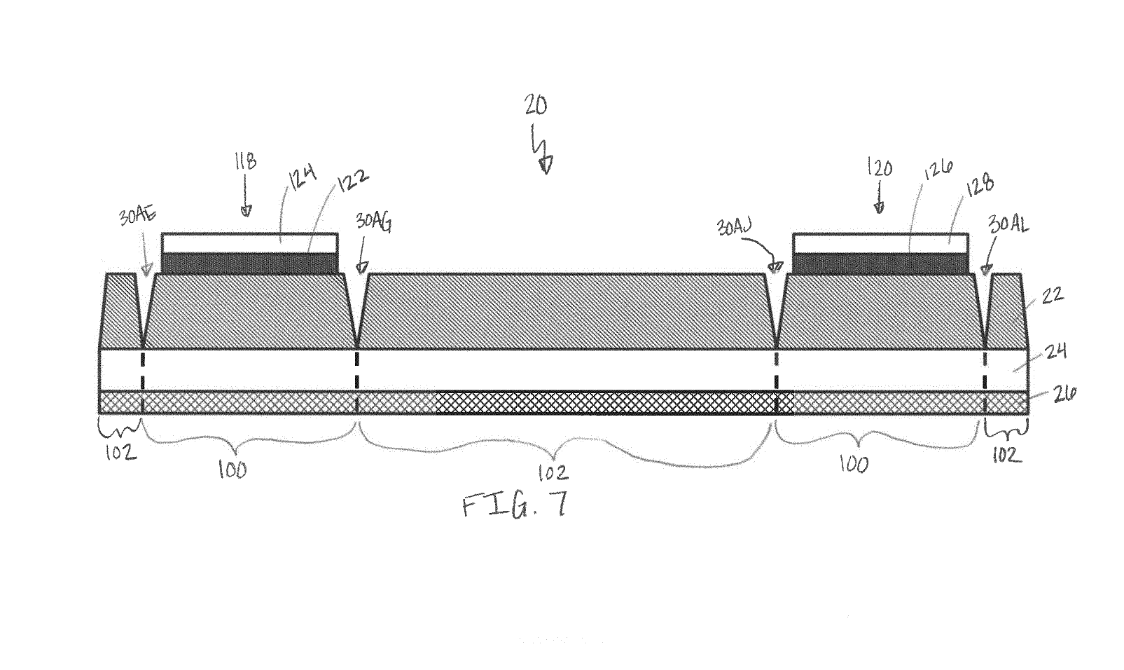

FIG. 7 is a side cross-sectional view of folder 100 in printable blank sheet 20, taken along line 7-7 of FIG. 6. Printable blank sheet 20 includes sheet layer 22, laminate layer 24, coating layer 26, slit-over-perforation lines 30AE, 30AG, 30AJ, and 30AL, folder 100, excess sheet area 102, first tab 118, second tab 120, first adhesive strip 122, first adhesive cover 124, second adhesive strip 126, and second adhesive cover 128.

Printable blank sheet 20 includes sheet layer 22, laminate layer 24, and coating layer 26. A bottom side of sheet layer 22 is attached to a top side of laminate layer 24, and a bottom side of laminate layer 24 is attached to a top side of coating layer 26. Slit-over-perforation lines 30AE, 30AG, 30AJ, and 30AL extend through printable blank sheet 20 and define the separation lines between folder 100 and excess sheet area 102. Folder 100 and excess sheet area 102 are held in printable blank sheet 20 and each include sheet layer 22, laminate layer 24, and coating layer 26.

Folder 100 includes first tab 118. First adhesive strip 122 and first adhesive cover 124 are positioned on first tab 118. First adhesive strip 122 is attached to a top side of sheet layer 22. First adhesive cover 124 is attached to a top side of first adhesives strip 122. Folder 100 includes second tab 120. Second adhesive strip 126 and second adhesive cover 128 are positioned on second tab 120. Second adhesive strip 126 is attached to a top side of sheet layer 22. Second adhesive cover 128 is attached to a top side of second adhesive strip 126.

Printable blank sheet 20 can be separated along slit-over-perforation lines 30AE, 30AG, 30AJ, and 30AL to facilitate the easy separation of folder 100 from printable blank sheet 20. To separate folder 100 from printable blank sheet 20 a user needs to bend printable blank sheet 20 along slit-over-perforation lines 30AE, 30AG, 30AJ, and 30AL. Bending printable blank sheet 20 along slit-over-perforation lines 30AE, 30AG, 30AJ, and 30AL will break apart slit-over-perforation lines 30AE, 30AG, 30AJ, and 30AL and separate folder 100 and excess sheet area 102 from printable blank sheet 20 along slit-over-perforation lines 30AE, 30AG, 30AJ, and 30AL. This process can continue for all slit-over-perforation lines 30AA-30AP shown in FIG. 6. Once all slit-over-perforation lines 30AA-30AP are separated, folder 100 and excess sheet area 102 should be separate pieces. Excess sheet area 102 can be discarded at this point and folder 100 can be used for its intended purpose.

Separating printable blank sheet 20 along slit-over-perforation lines 30AA-30AP is advantageous, as the separations will leave clean edges. Having clean edges is beneficial, as it give the final product a more polished and professional look. Being able to print custom print materials without having to send the materials to a print shop will save time and money for a user. Slit-over-perforation lines 30AA-30AP allow the user to print their own custom print materials on printable blank sheet 20 that has as high of a quality as something that is sent to a specialty print shop. Further, using laminate layer 24 with a high strength is advantageous, as it supports printable blank sheet 20 as it is passed through a printer or copier and prevents printable blank sheet 20, and the resulting folder 100, from tearing.

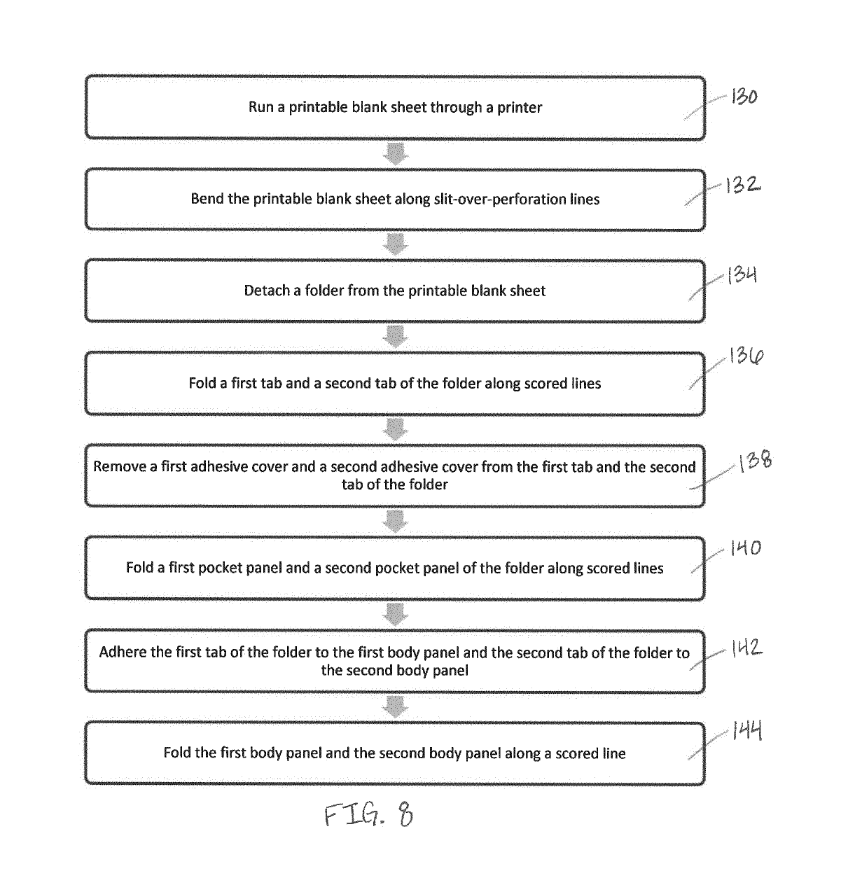

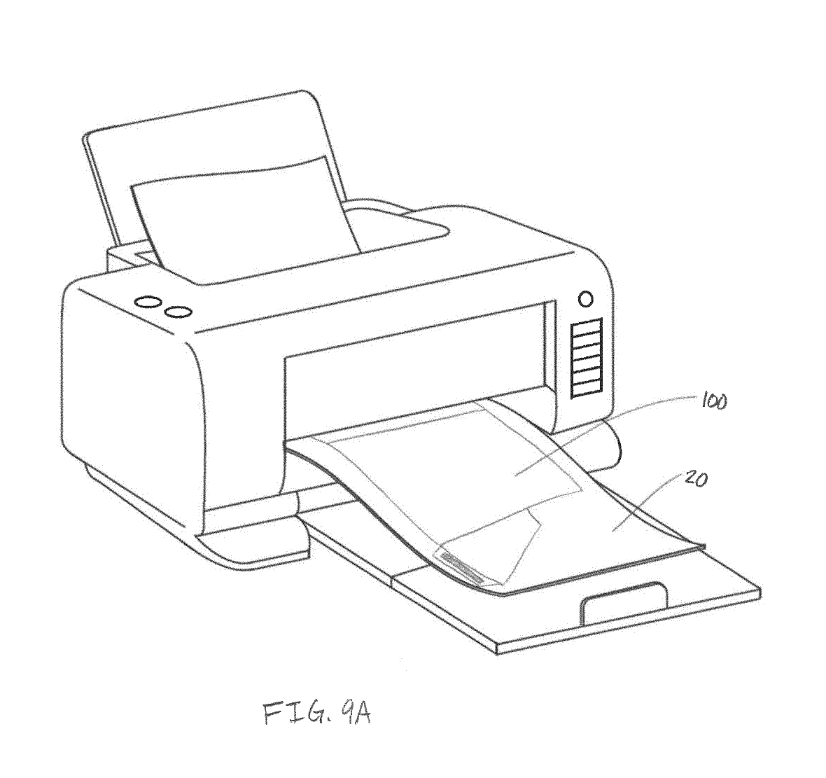

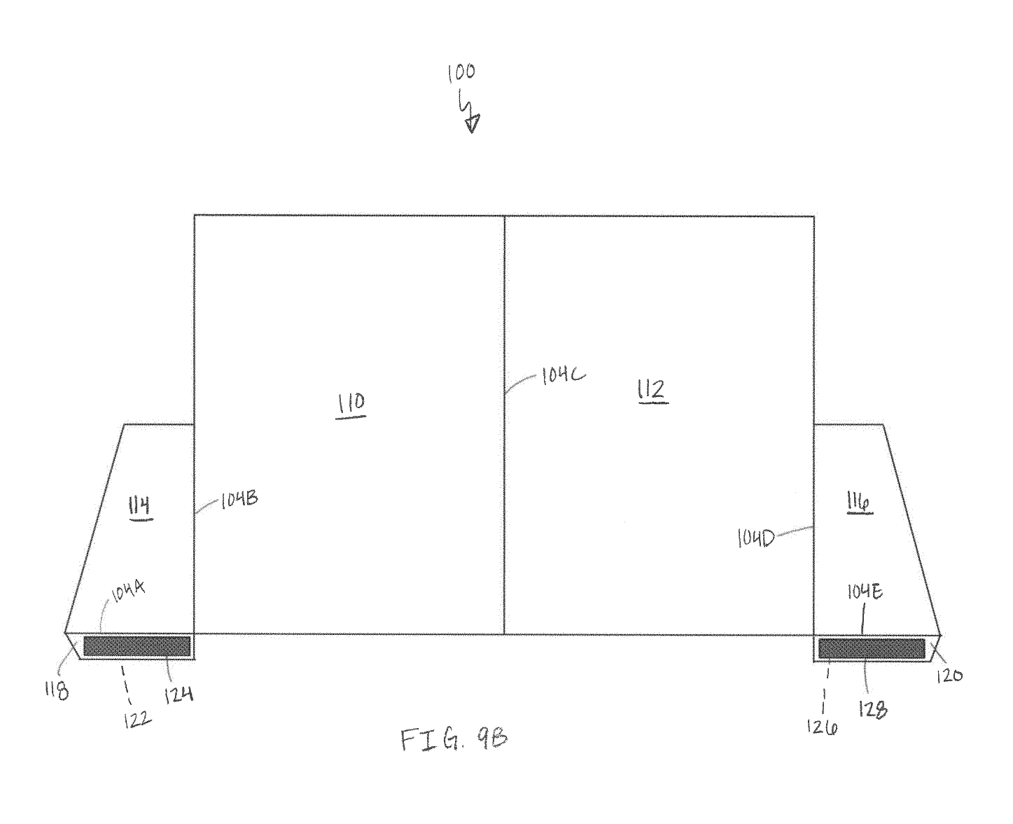

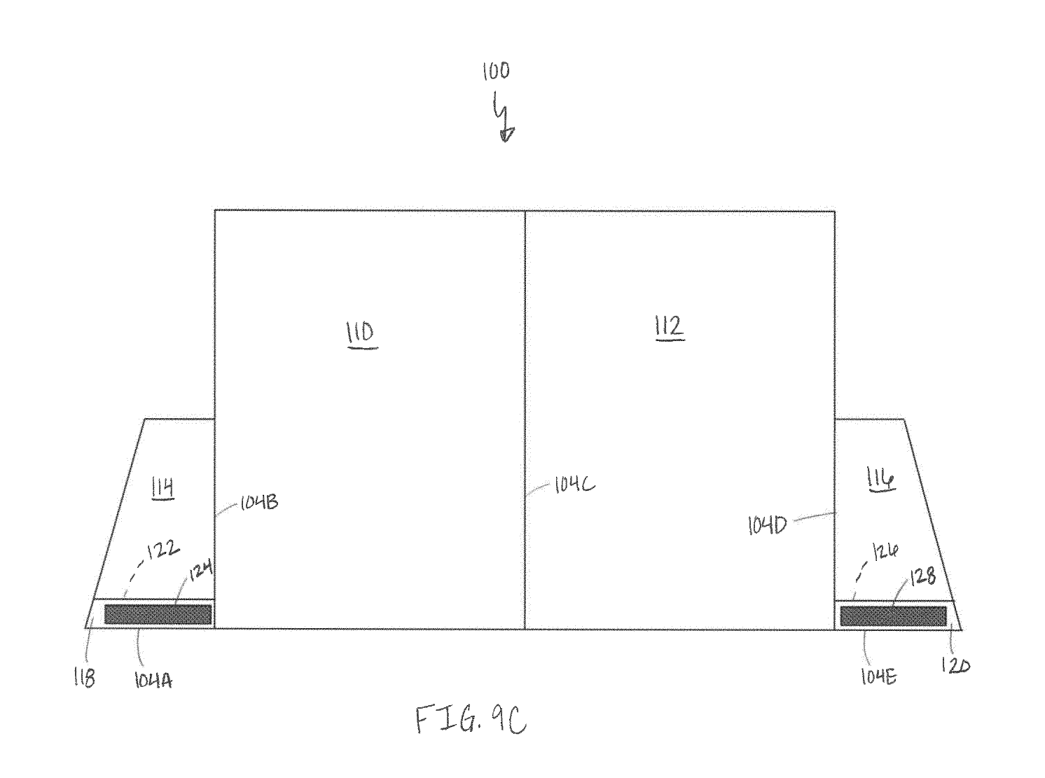

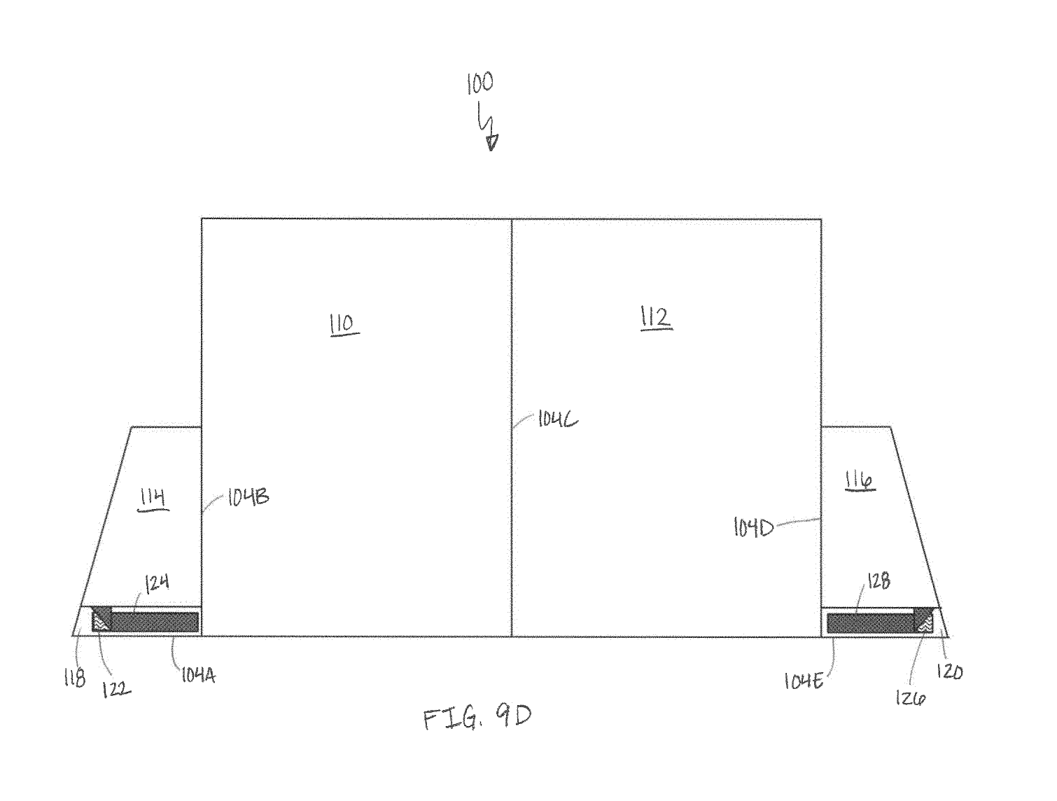

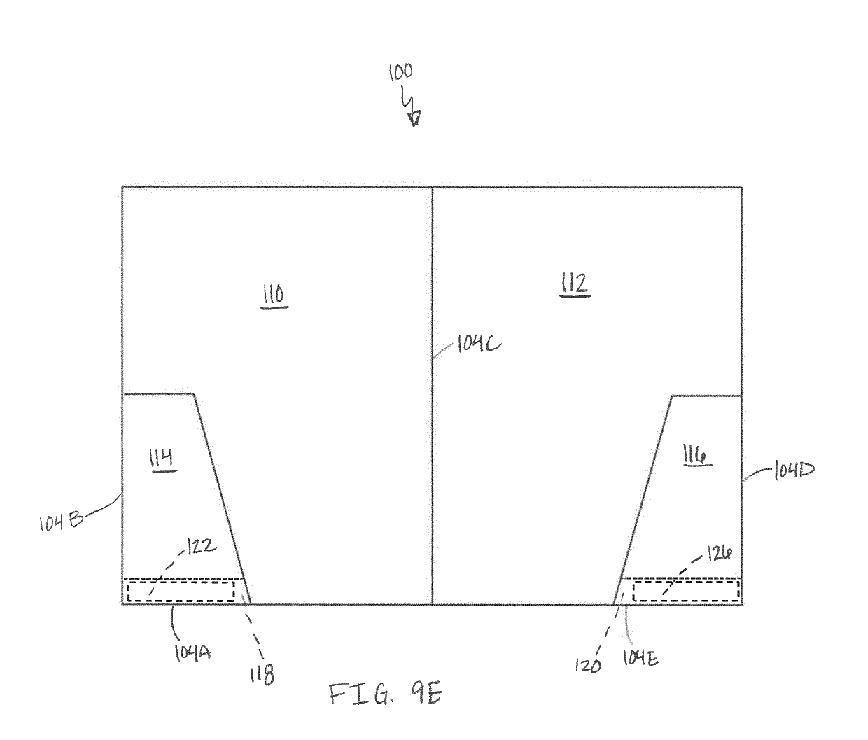

FIG. 8 is a flowchart showing how folder 100 can be formed. FIG. 8 includes steps 130, 132, 134, 136, 138, 140, 142, and 144 to show how folder 100 can be formed. FIGS. 9A-9E illustrate steps 130-144 shown in the flow chart in FIG. 8. FIG. 9A is a perspective view of printable blank sheet 20 as it is being run through a printer. FIG. 9B is a top plan view of folder 100 after it has been removed from printable blank sheet 20. FIG. 9C is a bottom plan view of folder 100 after first tab 118 and second tab 120 have been folded along scored lines 104A and 104E. FIG. 9D is a bottom plan view of folder 100 as first adhesive cover 124 and second adhesive cover 128 are removed from first tab 118 and second tab 120. FIG. 9E is a top plan view of folder 100 after first pocket panel 114 and second pocket panel 116 have been folded along scored lines 104B and 104D.

Step 130 includes running printable blank sheet 20 through a printer or copier, as shown in FIG. 9A. Printable blank sheet 20 will be supplied to a user from a manufacturer and will contain slit-over-perforation lines 30AA-30AP when it is given to the user. Slit-over-perforation lines 30AA-30AP will define the outline of folder 100 in printable blank sheet 20 and will indicate defined separation lines. Printable blank sheet 20 includes sheet layer 22, laminate layer 24, and coating layer 26, as shown in FIG. 7. Both sheet layer 22 and coating layer 26 are capable of being printed on, thus printable blank sheet 20 can be printed on both sides. Prior to printing on printable blank sheet 20, a template on a computer can be used to create the custom image that is to be printed on printable blank sheet 20, and specifically folder 100.

Printable blank sheet 20 includes folder 100 that is positioned in printable blank sheet 20. A user can print on first body panel 110, second body panel 112, first pocket panel 114, and second pocket panel 116 so that this information is viewable to users. Automatic imposition software can be used to create the design that is to be printed on printable blank sheet 20. The automatic imposition software allows a user to create the design and orient the design so that it positioned properly on folder 100 in printable blank sheet 20.

Step 132 includes bending printable blank sheet 20 along slit-over-perforation lines 30AA-30AP. Slit-over-perforation lines 30AA-30AP define the periphery of folder 100 in printable blank sheet 20. To separate printable blank sheet 20 along slit-over-perforation lines 30AA-30AP, the user can bend printable blank sheet 20 along slit-over-perforation lines 30AA-30AP. As printable blank sheet 20 is bent along slit-over-perforation lines 30AA-30AP, slit-over-perforation lines 30AA-30AP will snap apart. When slit-over-perforation lines 30AA-30AP are snapped apart, they will leave a clean-edge on the portion of printable blank sheet 20 that has been separated.

Step 134 includes detaching folder 100 from printable blank sheet 20. To separate folder 100 from printable blank sheet 20, the user can bend printable blank sheet 20 along each slit-over-perforation line 30AA-30AP to break them apart. This will detach folder 100 and excess sheet areas 102 from printable blank sheet 20. Each side of folder 100 can be detached from printable blank sheet 20 along a slit-over-perforation line 30AA-30AP. After folder 100 is separated from printable blank sheet 20, excess sheet area 102 can be discarded.

Step 136 includes folding first tab 118 and second tab 120 of folder 100 along scored lines 104A and 104E, respectively. FIG. 9B shows folder 100 after it has been removed from printable blank sheet 20. As seen in FIG. 9B, scored line 104A connects first tab 118 to first pocket panel 114. Scored line 104E connects second tab 120 to second pocket panel 116. First tab 118 is folded along scored line 104A so that first adhesive strip 122 and first adhesive cover 124 face away from first pocket panel 114 when first tab 118 has been folded along scored line 104A. Second tab 120 is folded along scored line 104E so that second adhesive strip 126 and second adhesive cover 128 face away from second pocket panel 116 when second tab 120 has been folded along scored line 104E. This can be seen in FIG. 9C.

Step 138 includes removing first adhesive cover 124 and second adhesive cover 128 from first tab 118 and second tab 120, respectively, of folder 100. As shown in FIG. 9C, first adhesive cover 124 covers first adhesive strip 122 on first tab 118, and second adhesive cover 128 covers second adhesive strip 126 on second tab 120. As shown in FIG. 9D, first adhesive cover 124 can be peeled off of first adhesive strip 122, and second adhesive cover 128 can be peeled off of second adhesive strip 126.

Step 140 includes folding first pocket panel 114 and second pocket panel 116 of folder 100 along scored lines 104B and 104D. As shown in FIG. 9B, scored line 104B connects first pocket panel 114 to first body panel 110, and scored line 104D connects second pocket panel 116 to second body panel 112. First pocket panel 114 is folded along scored line 104B towards first body panel 110, and second pocket panel 116 is folded along scored line 104D towards second body panel 112.

Step 142 includes adhering first tab 118 of folder 100 to first body panel 110 and second tab 120 of folder 100 to second body panel 112. As first pocket panel 114 is folded along scored line 104B towards first body panel 110, first adhesive strip 122 on first tab 118 will adhere to first body panel 110. As second pocket panel 116 is folded along scored line 104D towards second body panel 112, second adhesive strip 126 on second tab 120 will adhere to second body panel 112. This can be seen in FIG. 9E. First adhesive strip 122 will hold first tab 118 in place on first body panel 110 to form a pocket with first pocket panel 114. Second adhesive strip 126 will hold second tab 120 in place on second body panel 112 to form a pocket with second pocket panel 116.

Step 144 includes folding first body panel 110 and second body panel 112 along scored line 104C. When first body panel 110 and second body panel 112 are folded along scored line 104C, first body panel 110 will form a front of folder 100 and second body panel 112 will form a back of folder 100.

Steps 130-144 can be performed in any suitable order in alternate embodiments. The method shown in steps 130-144 is advantageous, as it allows a user to easily separate folder 100 from printable blank sheet 20. Minimal effort needs to be expended on the behalf of the user, as slit-over-perforation lines 30AA-30AP will easily snap apart when they are folded. Further, separating folder 100 from printable blank sheet 20 along slit-over-perforation lines 30AA-30AP will leave folder 100 with clean edges. Having clean edges is advantageous, as it presents a more polished and professional look. This method is also advantageous, as it allows a user to print their own custom print materials, which saves time and money.

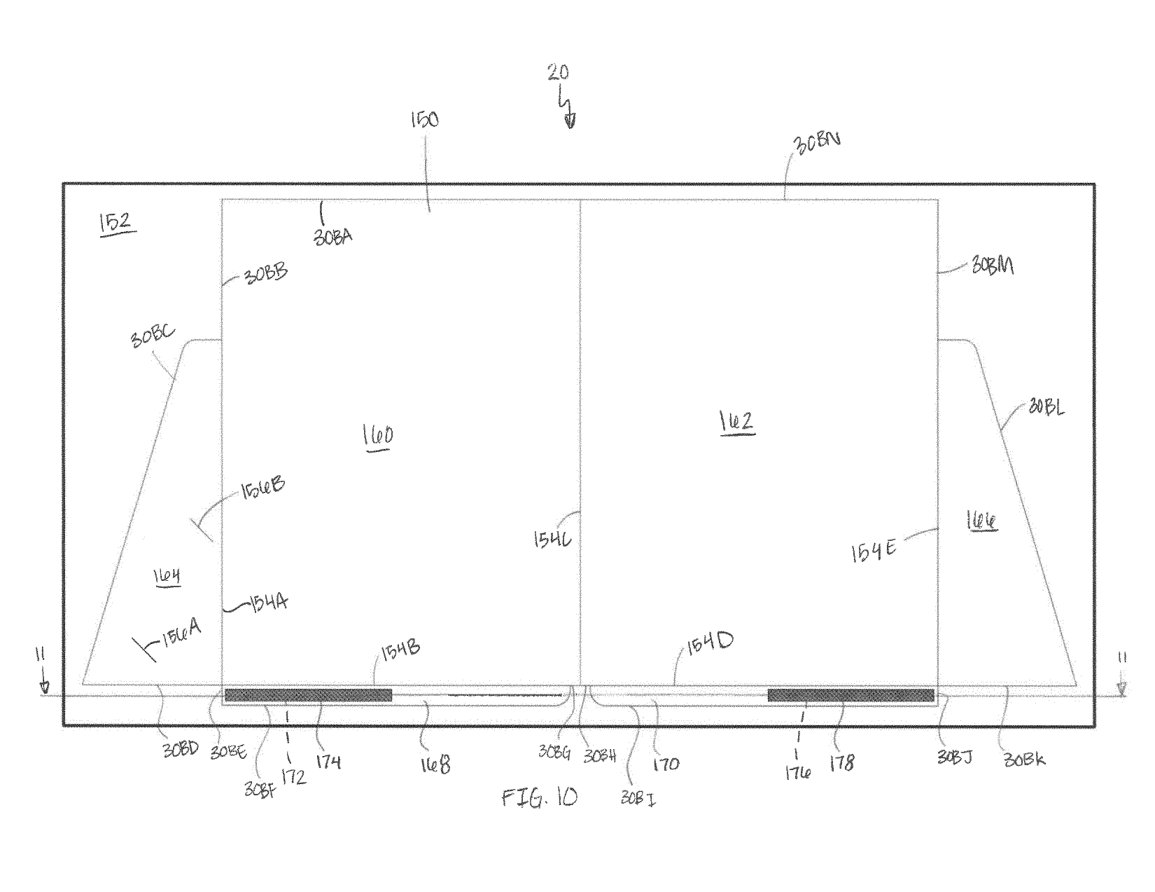

FIG. 10 is a top plan view of folder 150 in printable blank sheet 20. Printable blank sheet 20 includes slit-over-perforation lines 30BA, 30BB, 30BC, 30BD, 30BE, 30BF, 30BG, 30BH, 30BI, 30BJ, 30BK, 30BL, 30BM, 30BN, folder 150, excess sheet area 152, scored lines 154A, 154B, 154C, 154D, and 154E, cut lines 156A and 156B, first body panel 160, second body panel 162, first pocket panel 164, second pocket panel 166, first tab 168, second tab 170, first adhesive strip 172, first adhesive cover 174, second adhesive strip 176, and second adhesive cover 178.

Printable blank sheet 20 is a flat sheet that is capable of being run through a printer. Printable blank sheet 20 includes a plurality of layers, including a sheet layer that is attached to a laminate layer and a coating on the laminate layer. Slit-over-perforation lines 30BA-30BN extend through printable blank sheet 20 and define the peripheries of folder 150. Folder 150 is positioned on printable blank sheet 20 and is capable of being removed from printable blank sheet 20 to be assembled into a folder. Excess sheet area 152 surrounds folder 150. After folder 150 has been removed from printable blank sheet 20, excess sheet area 152 can be discarded. Slit-over-perforation lines 30BA-30BN define the periphery of folder 150 along which folder 150 can be removed from printable blank sheet 20. Slit-over-perforation lines 30BA-30BN include a cut through a sheet layer and perforations through a laminate layer and a coating, as described in reference to FIG. 1 above. Scored lines 154A-154E are placed on folder 150 and define areas where folder 150 can be folded. Scored lines 154A-154E are areas where printable blank sheet 20 has been put under pressure to create a line of weakness in printable blank sheet 20 along which printable blank sheet 20 can be easily folded.

Folder 150 includes first body panel 160, second body panel 162, first pocket panel 164, second pocket panel 166, first tab 168, and second tab 170. First body panel 160 has sides made of slit-over-perforation line 30BA, slit-over-perforation line 30BB, scored line 154A, scored line 154B, slit-over-perforation line 30BG, and scored line 154C. Second body panel 162 has sides made of slit-over-perforation line 30BN, scored line 154C, slit-over-perforation line 30BH, scored line 154D, scored line 154E, and slit-over-perforation line 30BM. First pocket panel 164 has sides made of slit-over-perforation line 30BC, slit-over-perforation line 30BD, and scored line 154A. Second pocket panel 166 has sides made of slit-over-perforation line 30BL, scored line 154E, and slit-over-perforation line 30BK. First tab 168 has sides made of scored line 154B, slit-over-perforation line 30BE, and slit-over-perforation line 30BF. Second tab 170 has sides made of scored line 154D, slit-over-perforation line 30BI, and slit-over-perforation line 30BJ.

First body panel 160 is connected to second body panel 162 along scored line 154C. First body panel 160 is connected to first pocket panel 164 along scored line 154A. Second body panel 162 is connected to second pocket panel 166 along scored line 154E. First tab 168 is connected to first body panel 160 along scored line 154B. Second tab 170 is connected to second body panel 162 along scored line 154D. Slit-over-perforation lines 30BA-30BN define an outline of folder 150. Cut lines 156A and 156B are positioned on first pocket panel 164. Cut lines 156A and 156B extend through the sheet layer, the laminate layer, and the coating layer of printable blank sheet 20. Cut lines 156A and 156B are positioned to hold a business card in folder 150.

First body panel 160 and second body panel 162 form a body portion of folder 150 when folder 150 is assembled. Folder 150 can be folded along scored line 154C so that first body panel 160 forms a front of folder 150 and second body panel 162 forms a back of folder 150. First pocket panel 164 forms a pocket on the left side of folder 150 when folder 150 is assembled, and second pocket panel 166 forms a pocket on the right side of folder 150 when folder 150 is assembled. First tab 168 is connected to first body panel 160 and can be adhered to first pocket panel 164 to form a pocket with first pocket panel 164. First adhesive strip 172 is positioned on first tab 168. First adhesive cover 174 covers first adhesive strip 172. First adhesive cover 174 can be removed to expose first adhesive strip 172. Second tab 170 is connected to second body panel 162 and can be adhered to second pocket panel 166 to form a pocket with second pocket panel 166. Second adhesive strip 176 is positioned on second tab 170. Second adhesive cover 178 covers second adhesive strip 176. Second adhesive cover 178 can be removed to expose second adhesive strip 176.

Printable blank sheet 20 can be run through a printer or copier to have an image printed on folder 150. After printing, folder 150 can be removed from printable blank sheet 20 by separating it from printable blank sheet 20 along slit-over-perforation lines 30BA-30BN. Folder 150 will then be free-standing.

When folder 150 has been removed from printable blank sheet 20, folder 150 is assembled by folding first pocket panel 164 along scored line 154A. First adhesive cover 174 is then removed to expose first adhesive strip 172. First tab 168 is then folded along scored line 154B and first adhesive strip 172 can be adhered to first pocket panel 164. Second pocket panel 166 can then be folded along scored line 154E. Second adhesive cover 178 is then removed to expose second adhesive strip 176. Second tab 170 is then folded along scored line 154D and second adhesive strip 176 can be adhered to second pocket panel 166. Folder 150 can then be folded along scored line 154C to form a presentation folder.

Forming folder 150 from printable blank sheet 20 is advantageous, as it allows a user to create custom print materials without having to order the materials from specialty print shops. This saves time and money for the user. Further, separating folder 150 along slit-over-perforation lines 30BA-30BN allows folder 150 to be easily separated from printable blank sheet 20. Further, slit-over-perforation lines 30BA-30BN leave a clean edge when they are separated, thus the quality and level of professionalism of custom print materials made with slit-over-perforation lines 30BA-30BN is similar to the quality and level of professionalism a user can get with specialty print shops.

Additionally, using laminate layer 24 (as shown in FIG. 1) with a high strength is advantageous, as it supports printable blank sheet 20 as it is passed through a printer or copier and prevents printable blank sheet 20 from tearing. Further, folder 150 will include laminate layer 24, which increases the strength of folder 150. Laminate layer 24 will make folder 150 stronger than previous paper structures and the film layer will make folder 150 moisture resistant. This allows folder 150 to be used in more settings, as stronger materials can be placed in folder 150 once they are assembled into three-dimensional structures and folder 150 can be used in harsher environments than was previously possible.

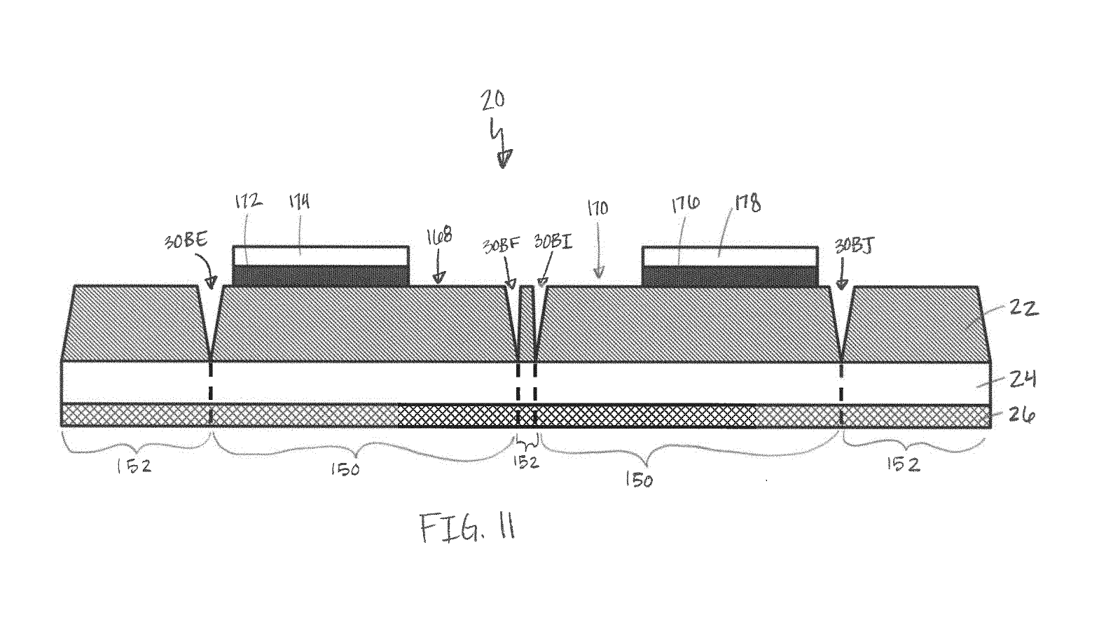

FIG. 11 is a side cross-sectional view of folder 150 in printable blank sheet 20, taken along line 11-11 of FIG. 10. Printable blank sheet 20 includes sheet layer 22, laminate layer 24, coating layer 26, slit-over-perforation lines 30BE, 30BF, 30BI, and 30BJ, folder 150, excess sheet area 152, first tab 168, second tab 170, first adhesive strip 172, first adhesive cover 174, second adhesive strip 176, and second adhesive cover 178.

Printable blank sheet 20 includes sheet layer 22, laminate layer 24, and coating layer 26. A bottom side of sheet layer 22 is attached to a top side of laminate layer 24, and a bottom side of laminate layer 24 is attached to a top side of coating layer 26. Slit-over-perforation lines 30BE, 30BF, 30BI, and 30BJ extend through printable blank sheet 20 and define the separation lines between folder 150 and excess sheet area 152. Folder 150 and excess sheet area 152 are held in printable blank sheet 20 and each include sheet layer 22, laminate layer 24, and coating layer 26.

Folder 150 includes first tab 168. First adhesive strip 172 and first adhesive cover 174 are positioned on first tab 168. First adhesive strip 172 is attached to a top side of sheet layer 22. First adhesive cover 174 is attached to a top side of first adhesives strip 172. Folder 150 includes second tab 170. Second adhesive strip 176 and second adhesive cover 178 are positioned on second tab 170. Second adhesive strip 176 is attached to a top side of sheet layer 22. Second adhesive cover 178 is attached to a top side of second adhesive strip 176.

Printable blank sheet 20 can be separated along slit-over-perforation lines 30BE, 30BF, 30BI, and 30BJ to facilitate the easy separation of folder 150 from printable blank sheet 20. To separate folder 150 from printable blank sheet 20 a user needs to bend printable blank sheet 20 along slit-over-perforation lines 30BE, 30BF, 30BI, and 30BJ. Bending printable blank sheet 20 along slit-over-perforation lines 30BE, 30BF, 30BI, and 30BJ will break apart slit-over-perforation lines 30BE, 30BF, 30BI, and 30BJ and separate folder 150 and excess sheet area 152 from printable blank sheet 20 along slit-over-perforation lines 30BE, 30BF, 30BI, and 30BJ. This process can continue for all slit-over-perforation lines 30BA-30BN shown in FIG. 10. Once all slit-over-perforation lines 30BA-30BN are separated, folder 150 and excess sheet area 152 should be separate pieces. Excess sheet area 152 can be discarded at this point and folder 150 can be used for their intended purpose.

Separating printable blank sheet 20 along slit-over-perforation lines 30BA-30BN is advantageous, as the separations will leave clean edges. Having clean edges is beneficial, as it give the final product a more polished and professional look. Being able to print custom print materials without having to send the materials to a print shop will save time and money for a user. Slit-over-perforation lines 30BA-30BN allow the user to print their own custom print materials on printable blank sheet 20 that has as high of a quality as something that is sent to a specialty print shop. Further, using laminate layer 24 with a high strength is advantageous, as it supports printable blank sheet 20 as it is passed through a printer or copier and prevents printable blank sheet 20, and the resulting folder 150, from tearing.

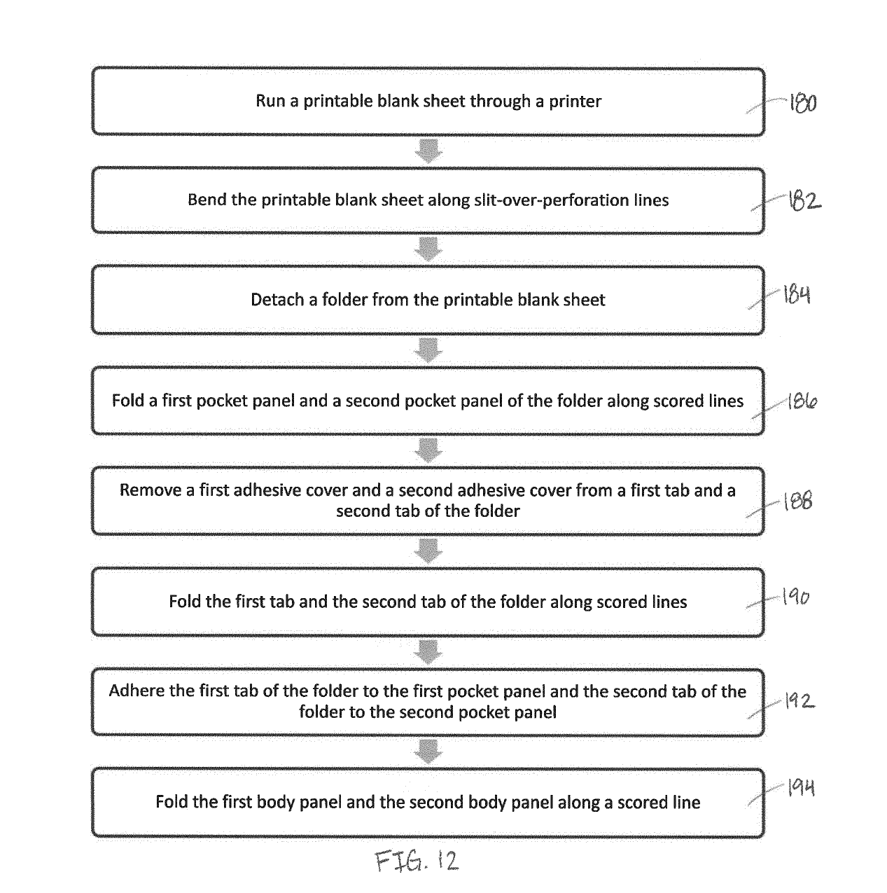

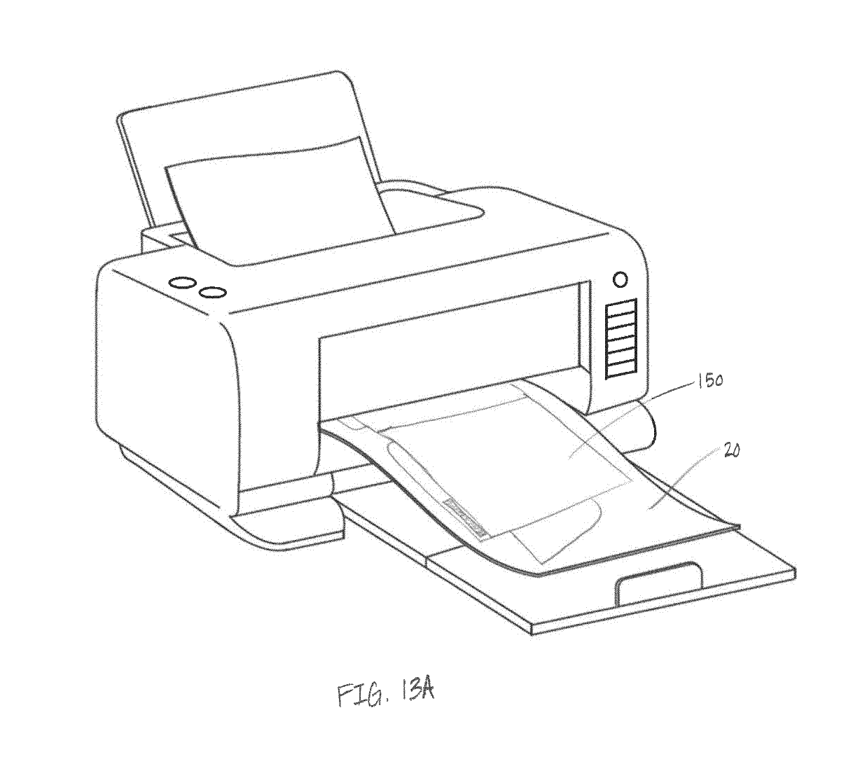

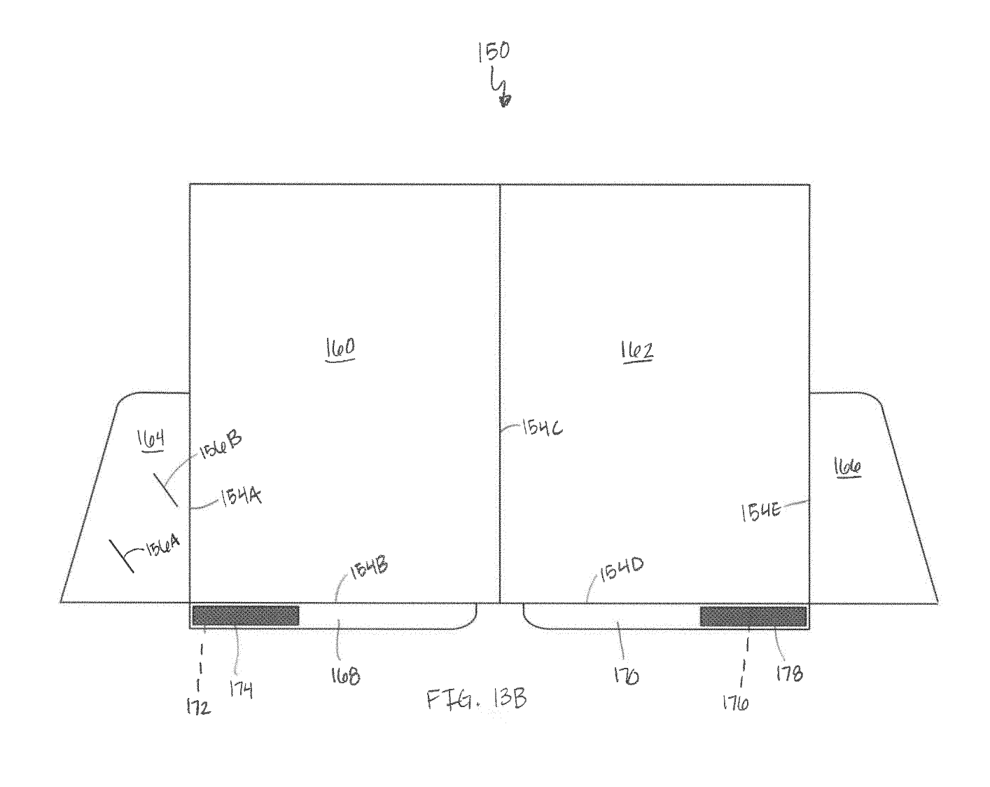

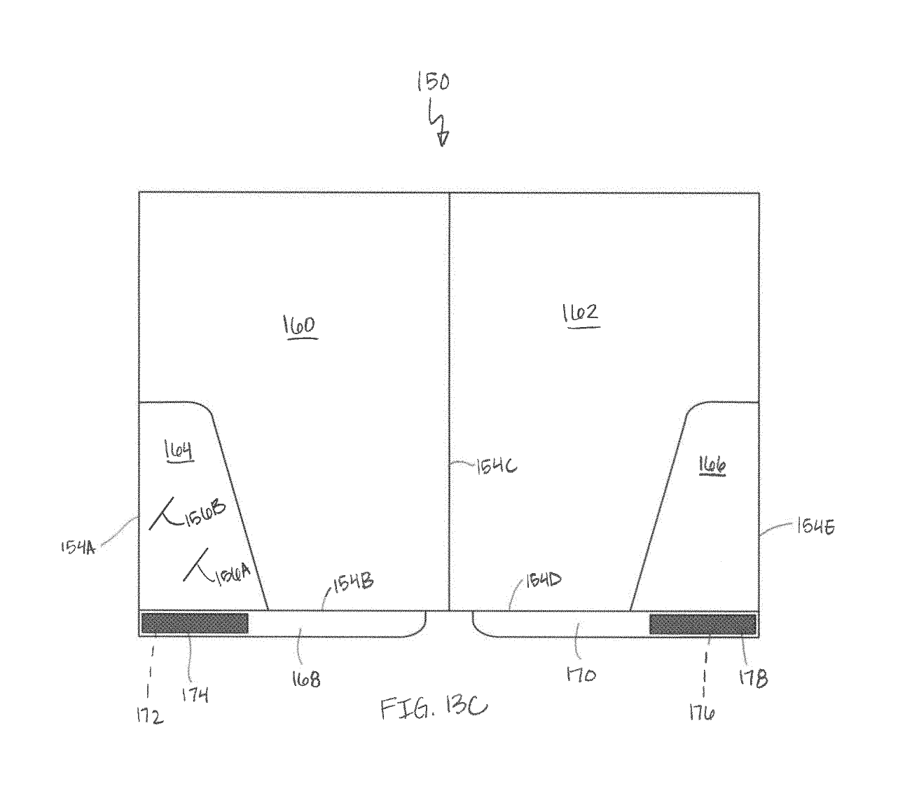

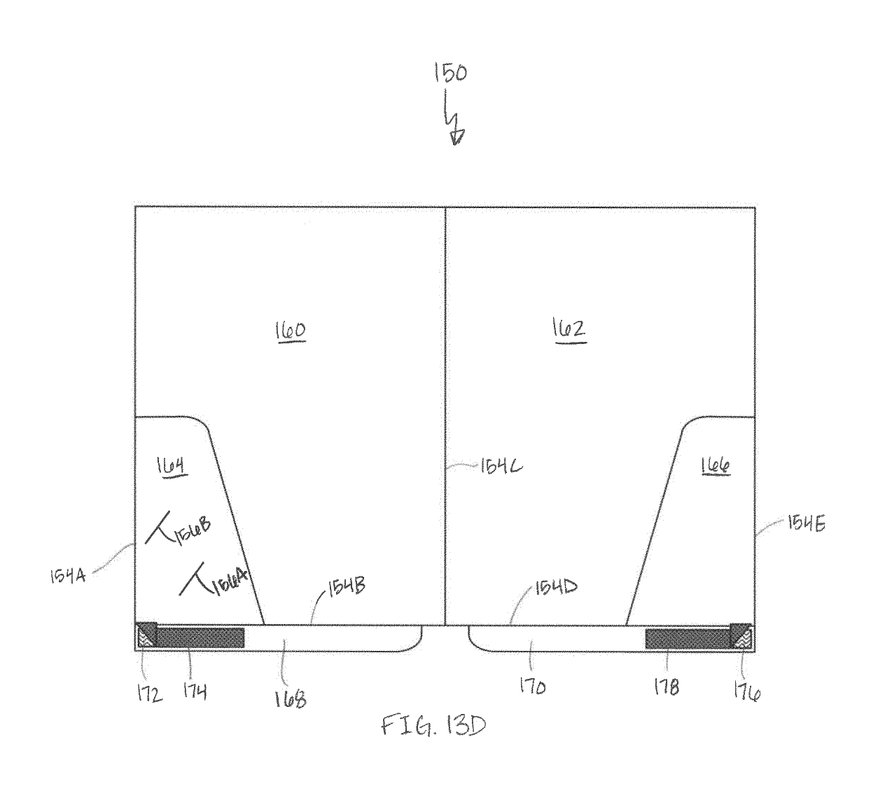

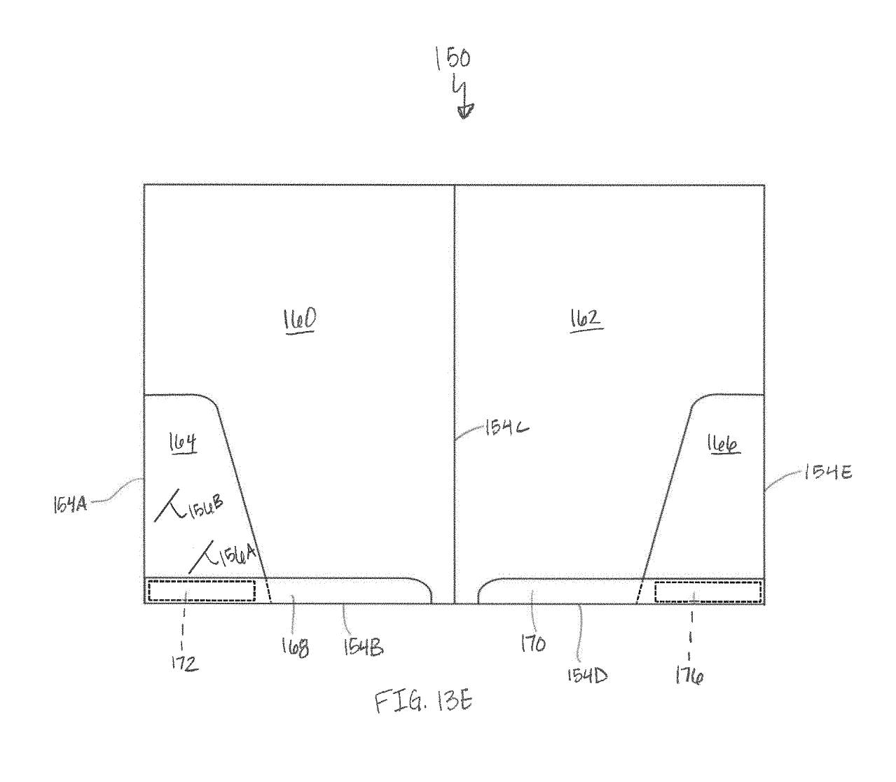

FIG. 12 is a flowchart showing how folder 150 can be formed. FIG. 8 includes steps 180, 182, 184, 186, 188, 190, 192, and 194, to show how folder 150 can be formed. FIGS. 13A-13E illustrate steps 180-194 shown in the flow chart in FIG. 12. FIG. 13A is a perspective view of printable blank sheet 20 as it is being run through a printer. FIG. 13B is a top plan view of folder 150 after it has been removed from printable blank sheet 20. FIG. 13C is a top plan view of folder 150 after first pocket panel 164 and second pocket panel 166 have been folded along scored lines 154A and 154E. FIG. 13D is a top plan view of folder 150 as first adhesive cover 174 and second adhesive cover 178 are removed from first tab 168 and second tab 170. FIG. 13E is a top plan view of folder 150 after first tab 168 and second tab 170 have been folded along scored lines 154B and 154D.

Step 180 includes running printable blank sheet 20 through a printer or copier, as shown in FIG. 13A. Printable blank sheet 20 will be supplied to a user from a manufacturer and will contain slit-over-perforation lines 30BA-30BN when it is given to the user. Slit-over-perforation lines 30BA-30BN will define the outline of folder 150 in printable blank sheet 20 and will indicate defined separation lines. Printable blank sheet 20 includes sheet layer 22, laminate layer 24, and coating layer 26, as shown in FIG. 11. Both sheet layer 22 and coating layer 26 are capable of being printed on, thus printable blank sheet 20 can be printed on both sides. Prior to printing on printable blank sheet 20, a template on a computer can be used to create the custom image that is to be printed on sheet 20, and specifically folder 150.

Printable blank sheet 20 includes folder 150 that is positioned in printable blank sheet 20. A user can print on first body panel 110, second body panel 112, first pocket panel 114, and second pocket panel 116 so that this information is viewable to users. Automatic imposition software can be used to create the design that is to be printed on printable blank sheet 20. The automatic imposition software allows a user to create the design and orient the design so that it positioned properly on folder 100 in printable blank sheet 20.

Step 182 includes bending printable blank sheet 20 along slit-over-perforation lines 30BA-30BN. Slit-over-perforation lines 30BA-30BN define the periphery of folder 150 in printable blank sheet 20. To separate printable blank sheet 20 along slit-over-perforation lines 30BA-30BN, the user can bend printable blank sheet 20 along slit-over-perforation lines 30BA-30BN. As printable blank sheet 20 is bent along slit-over-perforation lines 30BA-30BN, slit-over-perforation lines 30BA-30BN will snap apart. When slit-over-perforation lines 30BA-30BN are snapped apart, they will leave a clean-edge on the portion of printable blank sheet 20 that has been separated.

Step 184 includes detaching folder 150 from printable blank sheet 20. To separate folder 150 from printable blank sheet 20, the user can bend printable blank sheet 20 along each slit-over-perforation line 30BA-30BN to break them apart. This will detach folder 150 and excess sheet area 152 from printable blank sheet 20. Each side of folder 150 can be detached from printable blank sheet 20 along a slit-over-perforation line 30BA-30BN. After folder 150 is separated from printable blank sheet 20, excess sheet area 152 can be discarded.

Step 186 includes folding first pocket panel 164 and second pocket panel 166 of folder 150 along scored lines 154A and 154E, respectively. FIG. 13B shows folder 150 after it has been removed from printable blank sheet 20. As seen in FIG. 13B, scored line 154A connects first pocket panel 164 to first body panel 160. Scored line 154E connects second pocket panel 166 to second body panel 162. First pocket panel 164 is folded along scored line 154A, and second pocket panel 166 is folded along scored line 154E, as shown in FIG. 13C.

Step 188 includes removing first adhesive cover 174 and second adhesive cover 178 from first tab 168 and second tab 170, respectively, of folder 150. As shown in FIG. 13C, first adhesive cover 174 covers first adhesive strip 172 on first tab 168, and second adhesive cover 178 covers second adhesive strip 176 on second tab 170. As shown in FIG. 13D, first adhesive cover 174 can be peeled off of first adhesive strip 172, and second adhesive cover 178 can be peeled off of second adhesive strip 176.

Step 190 includes folding first tab 168 and second tab 170 of folder 150 along scored lines 154B and 154D. As shown in FIG. 13B, scored line 154B connects first tab 168 to first body panel 160, and scored line 154D connects second tab 170 to second body panel 162. First tab 168 is folded along scored line 154B towards first body panel 110, and second tab 170 is folded along scored line 154D towards second body panel 112.

Step 192 includes adhering first tab 168 of folder 150 to first body panel 160 and second tab 170 of folder 150 to second body panel 162. As first tab 168 is folded along scored line 154B towards first body panel 160, first adhesive strip 172 on first tab 168 will adhere to first pocket panel 164. As second tab 170 is folded along scored line 154D towards second body panel 162, second adhesive strip 176 on second tab 170 will adhere to second body panel 162. This can be seen in FIG. 13E. First adhesive strip 172 will hold first tab 168 in place on first pocket panel 164 to form a pocket with first pocket panel 164. Second adhesive strip 176 will hold second tab 170 in place on second pocket panel 166 to form a pocket with second pocket panel 166.

Step 194 includes folding first body panel 160 and second body panel 162 along scored line 154C. When first body panel 160 and second body panel 162 are folded along scored line 154C, first body panel 160 will form a front of folder 150 and second body panel 162 will form a back of folder 150.

Steps 180-194 can be performed in any suitable order in alternate embodiments. For example, first tab 168 and second tab 170 can first be folded along scored line 154B and scored line 154D, respectively, so that first adhesive strip 172 and second adhesive strip 176 face outwards from first body panel 160 and second body panel 162. First adhesive cover 174 and second adhesive cover 178 can then be removed from first adhesive strip 172 and second adhesive strip 176, respectively. First pocket panel 164 and second pocket panel 166 can then be folded along scored line 154A and scored line 154E, respectively, towards first adhesive strip 172 and second adhesive strip 176. First pocket panel 164 and second pocket panel 166 can then be adhered to first adhesive strip 172 and second adhesive strip 176, respectively. Part of first tab 168 will thus be positioned between first body panel 160 and first pocket panel 164, and part of second tab 170 will thus be positioned between second body panel 162 and second pocket panel 166.

The method shown in steps 180-194 is advantageous, as it allows a user to easily separate folder 150 from printable blank sheet 20. Minimal effort needs to be expended on the behalf of the user, as slit-over-perforation lines 30BA-30BN will easily snap apart when they are folded. Further, separating folder 150 from printable blank sheet 20 along slit-over-perforation lines 30BA-30BN will leave folder 150 with clean edges. Having clean edges is advantageous, as it presents a more polished and professional look. This method is also advantageous, as it allows a user to print their own custom print materials, which saves time and money.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A printable blank sheet comprising:
a sheet with a first layer and a second layer attached to a bottom side of the first layer;
slit-over-perforation lines extending through the sheet, wherein the slit-over-perforation lines comprise:
cuts running through the first layer; and
perforations running through the second layer;
a folder cut into the sheet with a periphery of the folder defined by the slit-over-perforation lines.

2. The printable blank sheet of claim 1, wherein the first layer is a sheet material that is capable of being printed on, and the second layer is a polyester material.

3. The printable blank sheet of claim 2, wherein the polyester material has an ultimate tensile strength between 70 MPa (10,152.64 psi) and 270 MPa (39,160.18 psi).

4. The printable blank sheet of claim 1, and further comprising:
a third layer attached to a bottom side of the second layer;
wherein the slit-over-perforation lines further comprise perforations running through the third layer along the slit-over-perforation lines.

5. The printable blank sheet of claim 4, wherein the third layer is a coating that is capable of being printed on.

6. The printable blank sheet of claim 1, and further comprising:
an excess sheet area surrounding the folder.

7. The printable blank sheet of claim 1, wherein the folder comprises:
a first body panel;
a second body panel connected to the first body panel along a first scored line;
a first pocket panel connected to the first body panel along a second scored line;
a second pocket panel connected to the second body panel along a third scored line;
a first tab connected to the first pocket panel along a fourth scored line; and
a second tab connected to the second pocket panel along a fifth scored line.

8. The printable blank sheet of claim 7, and further comprising:
a first adhesive strip on the first tab;
a first adhesive cover positioned over the first adhesive strip;
a second adhesive strip on the second tab; and
a second adhesive cover positioned over the second adhesive strip.

9. The printable blank sheet of claim 1, wherein the folder comprises:
a first body panel;
a second body panel connected to the first body panel along a first scored line;
a first pocket panel connected to the first body panel along a second scored line;
a second pocket panel connected to the second body panel along a third scored line;
a first tab connected to the first body panel along a fourth scored line; and
a second tab connected to the second body panel along a fifth scored line.

10. The printable blank sheet of claim 9, and further comprising:
a first adhesive strip on the first tab;
a first adhesive cover positioned over the first adhesive strip;
a second adhesive strip on the second tab; and
a second adhesive cover positioned over the second adhesive strip.

11. A printable blank sheet comprising:
a sheet with a sheet layer attached to a top side of a laminate layer, and a coating layer attached to a bottom side of the laminate layer;
slit-over-perforation lines extending through the sheet, wherein the slit-over-perforation lines comprise:
cuts running through the sheet layer along the slit-over-perforation lines;
perforations running through the laminate layer along the slit-over-perforation lines; and
perforations running through the coating layer along the slit-over-perforation lines;
a folder cut into the sheet with a periphery of the folder defined by the slit-over-perforation lines;
a first adhesive strip positioned on the folder;
a first adhesive cover positioned over the first adhesive strip;
a second adhesive strip positioned on the folder; and
a second adhesive cover positioned over the second adhesive strip.

12. The sheet of claim 11, wherein the laminate layer is a polymer material with an ultimate tensile strength between 70 MPa (10,152.64 psi) and 270 MPa (39,160.18 psi).

13. The sheet of claim 11, wherein the perforations running through the laminate layer and coating layer have a width between 0.8 millimeters (0.0315 inches) and 2 millimeters (0.0787 inches).

14. The printable blank sheet of claim 11, wherein the folder comprises:
a first body panel;
a second body panel connected to the first body panel along a first scored line;
a first pocket panel connected to the first body panel along a second scored line;
a second pocket panel connected to the second body panel along a third scored line;
a first tab connected to the first pocket panel along a fourth scored line; and
a second tab connected to the second pocket panel along a fifth scored line.

15. The printable blank sheet of claim 14, wherein:
the first adhesive strip is positioned on the first tab of the folder and is configured to adhere the first tab to the first folder panel; and
the second adhesive strip is positioned on the second tab of the folder and is configured to adhere the second tab to the second folder panel.

16. The printable blank sheet of claim 11, wherein the folder comprises:
a first body panel;
a second body panel connected to the first body panel along a first scored line;
a first pocket panel connected to the first body panel along a second scored line;
a second pocket panel connected to the second body panel along a third scored line;
a first tab connected to the first body panel along a fourth scored line; and
a second tab connected to the second body panel along a fifth scored line.

17. The printable blank sheet of claim 16, wherein:
the first adhesive strip is positioned on the first tab of the folder and is configured to adhere the first tab to the first pocket panel; and
the second adhesive strip is positioned on the second tab of the folder and is configured to adhere the second tab to the second pocket panel.

18. A method for creating custom folders, the method comprising:
running a printable blank sheet through a printer, wherein the printable blank sheet includes a first layer and a second layer attached to a bottom side of the first layer, wherein slit-over-perforation lines extend through the sheet and define a periphery of a folder in the sheet, wherein the slit-over-perforation lines include cuts extending through the first layer and perforations extending through the second layer;
bending the sheet along the slit-over-perforation lines to weaken and separate the slit-over-perforation lines; and
detaching the folder from the sheet.

19. The method of claim 18, and further comprising:
folding a first tab along a first scored line and a second tab along a second scored line;
removing a first adhesive cover from a first adhesive strip on the first tab and a second adhesive cover from a second adhesive strip on the second tab;
folding a first pocket panel along a third scored line and a second pocket panel along a fourth scored line;
adhering the first tab to a first body panel and the second tab to a second body panel; and
folding the first body panel and the second body panel along a fifth scored line to form a folder.

20. The method of claim 18, and further comprising:
folding a first pocket panel along a first scored line and a second pocket panel along a second scored line;
removing a first adhesive cover from a first adhesive strip on a first tab and a second adhesive cover from a second adhesive strip on a second tab;
folding the first tab along a third scored line and the second tab along a fourth scored line;
adhering the first tab to the first pocket panel and the second tab to the second pocket panel; and
folding a first body panel and a second body panel along a fifth scored line to form a folder.
